(19) United States
(12) Patent Application Publication
(10) Pub. No.: US 2021/0323211 A1
(43) Pub. Date: Oct. 21, 2021

(54) Coating System and Method

(71) Applicant: Tecton Products, LLC, Fargo, ND (US)

(72) Inventors: Robert P. Plagemann, Fargo, ND (US); Neena Ravindran, Fargo, ND (US)

(21) Appl. No.: 17/318,662

(22) Filed: May 12, 2021

Related U.S. Application Data
(63) Continuation-in-part of application No. 16/379,164, filed on Apr. 9, 2019.
(60) Provisional application No. 62/654,830, filed on Apr. 9, 2018.

(51) Int. Cl. B29C 48/154; C08L 27/16; C08L 33/08; C08L 33/12; C09D 4/00

(52) U.S. Cl. CPC B29C 48/154; C08L 27/16; C09D 4/00; C08L 33/12; C08L 33/08

(57) ABSTRACT

A coated article comprises a composite substrate with an outer surface and a coating comprising a protective bilayer. The bilayer includes a first thermoplastic protective layer comprising an inner face coupled to the composite substrate outer surface. The first protective layer is a first acrylic or acrylic-based polymer. The bilayer also includes a second thermoplastic protective layer coupled to the first protective layer at an interface. The second protective layer includes an outer face that opposes the interface. The second protective layer is formed from a blend of a first thermoplastic polymer and a second thermoplastic polymer. The first thermoplastic polymer comprises a fluoropolymer comprising polymerized monomer units derived from a hydrofluoro-olefin or a perfluorinated alkene or a combination thereof. The second thermoplastic polymer comprises a second acrylic or acrylic-based polymer. The first thermoplastic polymer is at least about 75 wt. % of the polymer blend.

### CROSS-REFERENCE TO RELATED APPLICATION

This application is a continuation-in-part of pending U.S. patent application Ser. No. 16/379,164, filed on Apr. 9, 2019, entitled “COATING SYSTEM AND METHOD,” which claims the benefit of priority to U.S. Provisional Patent Application Ser. No. 62/654,830, filed on Apr. 9, 2018, entitled “COATING SYSTEM AND METHOD,” the disclosures of which are incorporated by reference herein in their entireties.

### BACKGROUND

Pultrusion is a continuous process for manufacturing a composite material that entails simultaneously pulling a reinforcement material through a resin impregnating processing equipment and peripheral manufacturing equipment and cross-head extruding the composite material onto a component. Pultrusion systems used in industry can include a resin mixer and a resin impregnator for impregnating or injecting the resin into the reinforcement material, such as one or more reinforcement fibers. The resin impregnated reinforcement material can be pulled through a heated die (e.g., a pultrusion die) to form a substrate. The resulting substrate formed by the pultrusion process can include a three-dimensional shape formed through one or more pultrusion dies.

In various examples, a pultrusion process can include coating the substrate, for example with a coating that can improve weatherability, durability, and aesthetics of the finished article.

### SUMMARY OF THE DISCLOSURE

The present disclosure describes systems and methods for producing one or more pultrusion articles having a coating. The present disclosure also describes coated pultrusion articles, e.g., made from one or more of the systems or methods described herein. In some examples, the systems and methods described herein provide for coating a substrate, such as a pultrusion substrate, having a coating that is particularly resistant to weathering under typical weather conditions that the coated pultrusion article can be exposed to when placed in an external environment.

In an example, the present disclosure describes a coated article comprising a composite substrate formed from a reinforcing feedstock at least partially embedded in a matrix polymer, the composite substrate comprising an outer surface and a coating comprising a protective bilayer. The protective bilayer includes a first thermoplastic protective layer comprising an inner face coupled to the outer surface of the composite substrate, wherein the first protective layer is formed from a first acrylic or acrylic-based polymer, and a second thermoplastic protective layer coupled to the first thermoplastic protective layer at an interface, wherein the interface opposes the inner face of the first protective layer, the second protective layer comprising an outer face that opposes the interface. The second thermoplastic protective layer is formed from a polymer blend of a first thermoplastic polymer and a second thermoplastic polymer, wherein the first thermoplastic polymer comprises a first fluoropolymer comprising polymerized first monomer units derived from a hydrofluoro-olefin, or a second fluoropolymer comprising polymerized second monomer units derived from a perfluorinated alkene, or a combination thereof, wherein the second thermoplastic polymer comprises a second acrylic or acrylic-based polymer, and wherein the first thermoplastic polymer is at least about 75 wt. % of the polymer blend.

In another example, the present disclosure describes a method of manufacturing a coated article, the method comprising forming a composite substrate comprising a reinforcing feedstock at least partially embedded in a matrix polymer, the composite substrate comprising an outer surface, applying a first thermoplastic material comprising a first acrylic or acrylic-based polymer onto at least a portion of the outer surface of the composite substrate to form a first protective layer comprising an inner face coupled to the outer surface of the composite substrate and an outer interface, and applying a second thermoplastic material onto at least a portion of the outer interface of the first protective layer to form a second protective layer coupled to the first protective layer at the outer interface such that the second protective layer has an outer face that opposes the outer interface. The second thermoplastic material comprises a polymer blend of a first thermoplastic polymer and a second thermoplastic polymer, wherein the first thermoplastic polymer comprises a first fluoropolymer comprising polymerized first monomer units derived from a hydrofluoro-olefin or a second fluoropolymer comprising polymerized second monomer units derived from a perfluorinated alkene, or a combination thereof, wherein the second thermoplastic polymer comprises a second acrylic or acrylic-based polymer, and wherein the first thermoplastic polymer is at least about 85 wt. % of the second thermoplastic material.

This summary is intended to provide an overview of subject matter of the present disclosure. It is not intended to provide an exclusive or exhaustive explanation of the invention. The detailed description is included to provide further information about the present disclosure.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 is a schematic diagram of an example system for manufacturing an example elongate pultrusion article with a coating.

FIG. 2 is a schematic diagram of another example system for manufacturing an example elongate pultrusion article with a coating.

FIGS. 3A and 3B are cross-sectional views of example pultrusion articles, for example that can be manufactured by the examples systems of FIG. 1 or 2.

FIGS. 4 and 5 are cross-sectional views of example pultrusion articles taken along line A-A in FIG. 3A.

FIG. 6 is a flow diagram of an example method of manufacturing an example elongate pultrusion article.

FIG. 7 is a bar graph of surface free energy measurements for the coated articles of EXAMPLE 1 and EXAMPLE 2.

FIG. 8 is a photograph of an apparatus used for a scrape adhesion test.

FIGS. 9A-9D are photographs of samples of coated articles of EXAMPLE 1 and EXAMPLE 2 after scrape adhesion testing.

FIG. 10 is a bar graph of a five finger scratch resistance test of coated articles of EXAMPLE 1, EXAMPLE 2, and EXAMPLE 3.

FIGS. 11 and 12 are graphs of capillary rheometry data for the coating materials of EXAMPLE 1, COMPARATIVE EXAMPLE 4, COMPARATIVE EXAMPLE 5, and COMPARATIVE EXAMPLE 6.

### DETAILED DESCRIPTION

The following detailed description includes references to the accompanying drawings, which form a part of the detailed description. The drawings show, by way of illustration, specific embodiments in which the invention may be practiced. These embodiments, which are also referred to herein as “examples,” are described in enough detail to enable those skilled in the art to practice the invention. The example embodiments may be combined, other embodiments may be utilized, or structural, and logical changes may be made without departing from the scope of the present invention. While the disclosed subject matter will be described in conjunction with the enumerated claims, it will be understood that the exemplified subject matter is not intended to limit the claims to the disclosed subject matter. The following detailed description is, therefore, not to be taken in a limiting sense, and the scope of the present invention is defined by the appended claims and their equivalents.

References in the specification to “one embodiment”, “an embodiment,” “an example embodiment,” etc., indicate that the embodiment described can include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

Values expressed in a range format should be interpreted in a flexible manner to include not only the numerical values explicitly recited as the limits of the range, but also to include all the individual numerical values or sub-ranges encompassed within that range as if each numerical value and sub-range is explicitly recited. For example, a range of “about 0.1% to about 5%” or “about 0.1% to 5%” should be interpreted to include not just about 0.1% to about 5%, but also the individual values (e.g., 1%, 2%, 3%, and 4%) and the sub-ranges (e.g., 0.1% to 0.5%, 1.1% to 2.2%, 3.3% to 4.4%) within the indicated range. The statement “about X to Y” has the same meaning as “about X to about Y,” unless indicated otherwise. Likewise, the statement “about X, Y, or about Z” has the same meaning as “about X, about Y, or about Z,” unless indicated otherwise.

The terms “a,” “an,” or “the” are used to include one or more than one unless the context clearly dictates otherwise. The term “or” is used to refer to a nonexclusive “or” unless otherwise indicated. Unless indicated otherwise, the statement “at least one of” when referring to a listed group is used to mean one or any combination of two or more of the members of the group. For example, the statement “at least one of A, B, and C” can have the same meaning as “A; B; C; A and B; A and C; B and C; or A, B, and C,” or the statement “at least one of D, E, F, and G” can have the same meaning as “D; E; F; G; D and E; D and F; D and G; E and F; E and G: F and G; D, E, and F; D, E, and G; D, F, and G; E, F, and G; or D, E, F, and G.” A comma can be used as a delimiter or digit group separator to the left or right of a decimal mark; for example, “0.000,1″” is equivalent to “0.0001.”

The term “about” as used herein can allow for a degree of variability in a value or range, for example, within 10%, within 5%, within 1%, within 0.5%, within 0.1%, within 0.05%, within 0.01%, within 0.005%, or within 0.001% of a stated value or of a stated limit of a range and includes the exact stated value or range.

The term “substantially” as used herein refers to a majority of, or mostly, such as at least about 50%, 60%, 70%, 80%, 90%, 95%, 96%, 97%, 98%, 99%, 99.5%, 99.9%, 99.99%, or at least about 99.999% or more, or 100%.

The term “layer,” as used in describing a layer of the substrate coatings, although used in the singular, can refer to a single layer of the particular material being described or can refer to a plurality of layers of the same material or substantially the same material. In this way, when the term “layer” is used, it will be understood to mean “one or more layers” unless the description expressly states that a specific structure comprises a “single layer” of the material.

In methods described herein, the steps can be carried out in any order without departing from the principles of the invention, except when a temporal or operational sequence is explicitly recited. Furthermore, specified acts can be carried out concurrently unless explicit language recites that they be carried out separately. For example, a recited act of doing X and a recited act of doing Y can be conducted simultaneously within a single operation, and the resulting process will fall within the literal scope of the process. Recitation in a claim to the effect that first a step is performed, then several other steps are subsequently performed, shall be taken to mean that the first step is commenced before any of the other steps, but the other steps can be performed in any suitable sequence, unless a sequence is further recited within the other steps. For example, claim elements that recite “Step A, Step B, Step C, Step D, and Step E” shall be construed to mean step A is carried out first, step E is carried out last, and steps B, C, and D can be carried out in any sequence between steps A and E, including concurrently with one on both of steps A and E, and that such a sequence still falls within the literal scope of the claimed process. A given step or sub-set of steps can also be repeated.

Furthermore, specified steps can be carried out concurrently unless explicit claim language recites that they be carried out separately. For example, a claimed step of doing X and a claimed step of doing Y can be conducted simultaneously within a single operation, and the resulting process will fall within the literal scope of the claimed process.

All publications, patents, and patent documents referred to in this document are incorporated by reference herein in their entirety, as though individually incorporated by reference. In the event of inconsistent usages between this document and those documents so incorporated by reference, the usage in the incorporated reference should be considered supplementary to that of this document; for irreconcilable inconsistencies, the usage in this document controls.

### Pultrusion Forming and Coating System

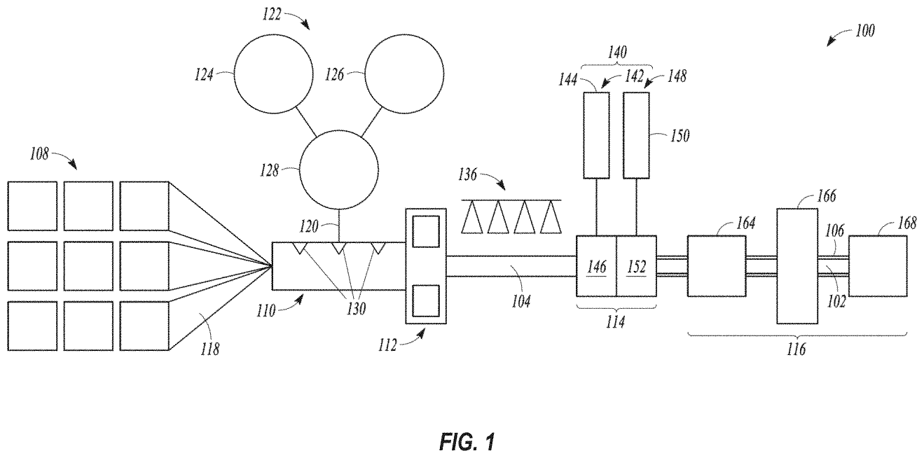

FIG. 1 shows a schematic diagram of an example system 100 for manufacturing a coated pultrusion article 102. In an example, the system 100 manufactures a pultruded substrate 104 and applies a coating 106 to the substrate 104 to provide the coated pultrusion article 102, e.g., wherein the coating 106 can be selected to provide one or more improved properties, such as at least one of improved aesthetics, improved color, or improved weatherability compared to the uncoated substrate 104. Therefore, for the sake of clarity and brevity, the system 100 may be referred to herein as a pultrusion and coating system 100, and the substrate 104 may be referred to herein as a pultrusion substrate 104.

In an example, the pultrusion and coating system 100 comprises a feed system 108, a resin-injection assembly 110, a pultrusion die 112, a coating system 114, and a finishing system 116. The feed system 108 provides a feedstock 118 to the pultrusion and coating system 100, and in particular, to the resin-injection assembly 110. The feedstock 118 can comprise one or more reinforcement structures to which a resin can be applied in order to provide a composite material in the form of the pultrusion substrate 104. In an example, the one or more reinforcement structures of the feedstock 118 can comprise one or more continuous fibers, such as one or more reinforcing fibers. Examples of the one or more reinforcing fibers that can be used as the reinforcement feedstock 118 in the pultrusion and coating system 100 include, but are not limited to, glass fibers, basalt fibers, carbon aramid fibers, Kevlar fibers, natural fibers, such as flax or hemp, among others.

The feed system 108 can include one or more systems to store and feed the feedstock 118 in such a manner that the feedstock 118 is continuously fed to the rest of the pultrusion and coating system 100. In an example, the feed system 108 includes a carting system and an aligning system that delivers or provides the feedstock 118 to another portion of the pultrusion and coating system 100. In an example, the feedstock 118 comprises one or more continuous reinforcing fibers and each of the one or more fibers are stored as a roving that is continuously fed to the other portion of the pultrusion and coating system 100.

In an example, the feed system 108 can deliver or provide the feedstock 118 to the resin-injection assembly 110. The resin-injection assembly 110 can include a resin feed device or devices to feed a polymer resin 120 to the feedstock 118. In an example, the resin-injection assembly 110 can inject the polymer resin 120 into contact with the feedstock 118. The resin-injection assembly 110 can sufficiently inject the polymer resin 120 so that the feedstock 118 is at least partially impregnated with and at least partially surrounded by the polymer resin 120.

In an example, the polymer resin 120 comprises a thermoset resin, such as a polyester resin or a polyester-based resin, a polyurethane resin or a polyurethane-based resin, or a vinyl ester or vinyl ester-based resin. In other examples, the polymer resin 120 comprises a low-viscosity thermoplastic resin, such as an acrylic-based thermoplastic such as a methyl methacrylate (MMA) based or methyl acrylate-based thermoplastic. In some examples, the polymer resin 120 can be formed by mixing one or more precursor compounds that, when combined, can form the desired final composition of the polymer resin 120. The polymer resin 120 can be pre-mixed or the resin-injection assembly 110 can include a resin-mixing system 122 that mixes one or more resin constituents to form a resin mixture having a specified composition. The resin-mixing system 122 can include a plurality of storage vessels each supplying a resin constituent. In an example, the resin-mixing system 122 includes a first resin storage vessel 124 for a first resin constituent and a second resin storage vessel 126 for a second resin constituent. The resin-mixing system 122 can optionally further include one or more additional storage vessels for one or more additional resin constituents, such as a third storage vessel for a third resin constituent, a fourth storage vessel for a fourth resin constituent, and so on. The plurality of storage vessels can be communicatively coupled to a mixing apparatus 128, such as a mixing vessel or a mixing device, wherein each corresponding resin constituent from the plurality of storage vessels 124, 126 can be mixed to provide the polymer resin 120 having the specified composition.

For example, in the case of a polyurethane or polyurethane-based resin, a first polyurethane constituent can comprise one or more polyols such that the first resin storage vessel 124 can be one or more polyol storage vessels. A second polyurethane constituent can comprise one or more isocyanates such that the second resin storage vessel 126 can be one or more isocyanate storage vessels. The one or more polyol storage vessels 122 and the one or more isocyanate storage vessels 124 can be communicatively coupled to the mixing apparatus 128 where the one or more polyols from the one or more polyol storage vessels 122 and the one or more isocyanates from the one or more isocyanate storage vessels 124 can be mixed to form a polyurethane-based polymer resin 120. Similar combinations of storage vessels 122, 124 and the mixing apparatus 128 can be set up for the formation of a polyester or polyester-based resin 120 or for the formation of other compositions of polymer resin 120, such as low-viscosity thermoplastic resin systems.

In an example, the polymer resin 120 that is applied to the feedstock 118 can include one or more fillers to modify physical properties of the polymer formed from the resin and of the pultrusion substrate 104. Examples of fillers that can be used in the polymer resin 120 include, but are not limited to, particles of calcium carbonate (CaCO₃), alumina trihydrate (AI₂O₃.3H₂O), talc (e.g., a mineral form of hydrated magnesium silicate, H₂Mg₃(SiO₃)₄), clay, or one or more types of glass filler particles (such as glass spheres). In an example, the resin-injection assembly 110 includes a feedstock alignment system to align the feedstock 118 in a desired configuration for resin impregnation.

The resin-mixing system 122 can include a pumping system that is communicatively coupled to the mixing apparatus 128. The pumping system can withdraw the polymer resin 120 from the mixing apparatus 128 and feed the resin mixture to one or more resin nozzles 130. Each of the one or more resin nozzles 130 can inject or otherwise apply the polymer resin 120 to the feedstock 118.

In an example, the feed system 108 can include one or more heating devices to heat at least one of: (a) one or more of the resin constituents, e.g., before mixing the one or more resin constituents; (b) the resin mixture within the mixing apparatus, e.g., after mixing of the one or more resin constituents; or (c) the resin mixture in a feed line between the mixing apparatus and the one or more resin nozzles, e.g., after withdrawing the resin mixture with the pumping system. Each of the one or more heating devices can heat the component being heated (e.g., one or more of the resin constituents or the resin mixture) to a specified temperature, e.g., to be more conducive to polymerization and formation of the polymer of the pultrusion substrate 104.

The feedstock 118 can be pulled or otherwise forced through the pultrusion die 112 to shape the feedstock 118 into a desired shape in the form of the pultrusion substrate 104. The pultrusion die 112 can produce a cross-sectional profile of the resin-injected feedstock 118. Examples of profiles that can be formed by the resin-injection assembly 110 and the pultrusion die 112 include, but are not limited to, pultrusion articles in the form of an architectural fenestration component, a building component, a solar component, a furniture component, a refrigeration component, or a component of a piece of agricultural equipment. Pultrusion of the resin-injected feedstock 118 through the pultrusion die 112 results in a pultrusion substrate 104 having one or more profile surfaces in a specified configuration to form the specified cross-sectional profile.

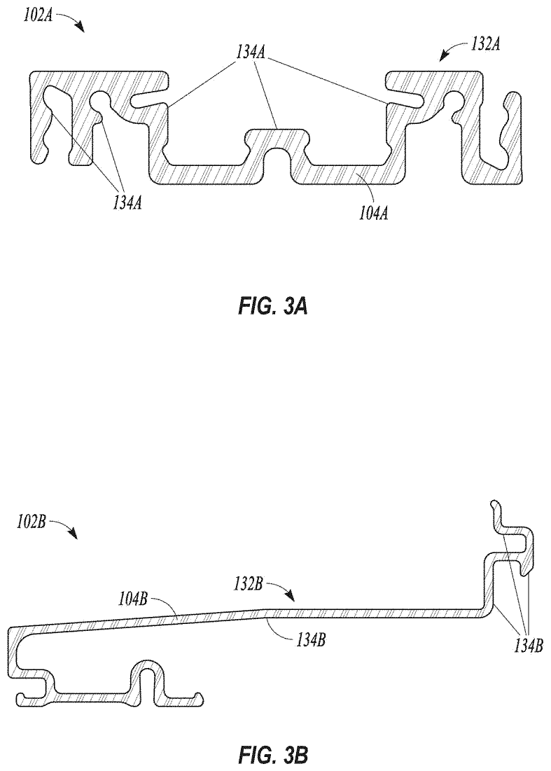

FIGS. 3A and 3B show two examples of coated articles 102A and 102B formed by coating pultrusion substrates 104A and 104B, wherein the pultrusion substrates 104A, 104B provide two examples of cross-sectional profiles 132A, 132B, respectively, that can be formed, for example using the pultrusion die 112. FIG. 3A shows a profile view of an example profile 132A for a modular patio door sill, while FIG. 3B shows a profile view of an example profile 132B for a window frame cladding. The specific profiles 132A, 132B of the pultrusion substrates 104A and 104B shown in FIGS. 3A and 3B are included as examples for illustration purposes only. As will be understood by a person of ordinary skill in the art, the systems, methods, and resulting articles described herein are not limited to the specific pultrusion profiles 132A and 132B or forms shown in FIGS. 3A and 3B. The profile 132 formed by pultruding the feedstock 118 through the pultrusion die 112 can include one or more profile surfaces 134A, 134B, e.g., outer surfaces of the pultrusion substrates 104A, 104B (best seen in FIGS. 3A and 3B).

Returning to FIG. 1, the pultrusion and coating system 100 can include one or more heating devices associated with the pultrusion die 112, such as one or more heaters, for example one or more integral die heaters or one or more heaters external to the pultrusion die 112, or both. The one or more heaters associated with the pultrusion die 112 can provide for thickening or gelling, or both, of the polymer resin 120, for example by initiating or continuing polymerization of the one or more resin constituents in the polymer resin. The one or more heating devices can also provide for full or partial curing of the polymer resin within or substantially immediately downstream of the pultrusion die 112.

In an example, the pultrusion and coating system 100 includes one or more pre-treatment operations to treat the pultrusion substrate 104 after it exits the pultrusion die 112 but before the pultrusion substrate 104 is fed into the coating system 114. Pretreatment can prepare the pultrusion substrate 104 for coating by the coating system 114. In an example, the pretreatment can prepare the surfaces onto which the coating 106 will be applied (for example the profile surfaces 134A, 134B on the pultrusion substrates 104A and 104B in FIGS. 3A and 3B) for bonding with the material of the coating 106. Examples of pretreatment operations include, but are not limited to, one or any combination of: heating the pultrusion substrate 104, such as by heating at least the surfaces to be coated (e.g., surfaces 134A and 134B in FIGS. 3A and 3B); cleaning one or more of the surfaces to be coated, such as with one or more solvents; abrasion treatment of one or more of the surfaces to be coated; or applying one or more chemical treatments, such as a plasma.

In the example shown in FIG. 1, the pretreatment of the pultrusion substrate 104 comprises heating the pultrusion substrate 104 with one or more in-line heaters 136 downstream of the pultrusion die 112. The one or more heaters 136 can be configured, or can be part of a temperature control system, to control or maintain a temperature of the pultrusion substrate 104 downstream of the pultrusion die 112 and before the pultrusion substrate 104 enters the coating system 114. In an example, the one or more heaters 136 can be configured to control or maintain a temperature of the pultrusion substrate 104 so that the portions of the one or more surfaces onto which the one or more layer of coating material is to be applied (such as the profile surfaces 134A and 134B in FIGS. 3A and 3B) to form the coating 106, will be at a specified temperature. The specified temperature can be a temperature that will perform one or more of the following: improved or optimized polymerization of the one or more constituents of the polymer resin 120 to form the final matrix polymer of the pultrusion substrate 104; improved adhesion of the coating 106 to the one or more surfaces being coated; or improved formation of the one or more coating material layers, e.g., via setting, gelling, or other polymerization of the one or more coating materials after application to the pultrusion substrate 104. In an example, the one or more heaters 136 include one or more infrared heaters that emit infrared radiation onto the pultrusion substrate 104. The pultrusion and coating system 100 can also include temperature sensors to measure a temperature of the pultrusion substrate 104 and to control an output of the one or more heaters 136 based on a measured temperature of the pultrusion substrate 104, e.g., in the manner of a feedback control loop.

In an alternative example, the pultrusion and coating system can omit in-line heaters (such as the one or more heaters 136 in FIG. 1A) are omitted, and the coating system can be located in close physical proximity to the exit of the pultrusion die. In an example, the exit of the pultrusion die can be in close physical proximity to the entrance to the first material extruder that is to coat a material onto the pultrusion substrate 104, i.e., the first coating material extruder 142. In such a system, the temperature of the pultrusion substrate exiting the pultrusion die can be controlled at the pultrusion die, e.g., with a heater within or immediately upstream of the pultrusion die that is controlled to not only provide a temperature that is conducive to setting or gelling of the matrix polymer, but also to provide a temperature of the pultrusion substrate exiting the pultrusion die that is conducive for coating with one or more coating materials.

Returning to FIG. 1, as noted above, the pultrusion and coating system 100 includes a coating system 114 to apply a coating 106 onto the pultrusion substrate 104, e.g., onto at least a portion of one or more surfaces of the pultrusion substrate 104 (such as the profile surfaces 134A, 134B in FIGS. 3A and 3B), to provide the coated pultrusion article 102. As described in more detail below, the coating 106 can include one or more coating layers that are coated onto the pultrusion substrate 104. The coating system 114 includes a coating-material application assembly 140 to apply one or more coating materials onto the pultrusion substrate 104 to form the one or more layers of the coating 106.

The coating-material application assembly 140 can include a coating material extruder 142 comprising a coating material storage vessel 144 and a coating material die 146. In an example, the coating-material application assembly 140 applies a single coating layer onto the pultrusion substrate 104. In such an example, the coating-material application assembly 140 may comprise only a single coating material extruder 142 of a single coating material storage vessel 144 feeding a single coating material die 146.

In another example, the coating-material application assembly 140 applies a plurality of coating layers onto the one or more tie layers to form the coated pultrusion article 102. Each layer of the plurality of coating layers can be formed from a different coating material composition, or each layer can comprise the same coating composition. In the example shown in FIG. 1, the pultrusion and coating system 100 is configured to form a coating 106 comprising two coating layers. In such an example, the coating-material application assembly 140 can include a first coating material extruder 142 configured to form a first coating layer on the pultrusion substrate 104 and a second coating material extruder 148 configured to form a second coating layer on the first coating layer. The first coating material extruder 142 can include a first coating material storage vessel 144 and a first coating die 146 configured to form a first coating layer, e.g., on top of one or more surfaces of the pultrusion substrate 104. The second coating material extruder 148 comprises a second coating material storage vessel 150 and a second coating die 152 to form a second coating layer, e.g., on top of the first coating layer. Different example configurations of one coating layer or two coating layers are described below. In various examples, the coating-material application assembly 140 includes a coating die 146, 152 for each coating layer or includes a coextrusion die to apply two or more coating layers at substantially the same time to the pultrusion substrate 104.

Examples of materials that can form each of the one or more coating layers include, but are not limited to, at least one of: one or more acrylics, one or more bioplastics, polyvinylchloride, poly(vinylidene difluoride), poly(tetrafluoroethylene), acrylonitrile-styrene-acrylate, acrylonitrile-butadiene-styrene (ABS) or other styrenic polymers, weather stock (e.g., weather capping or a weather resistant coating), aesthetic coatings, texturization coatings, one or more clear-coat materials, one or more primer compositions, or blends thereof. As described in more detail below, in an example, the coating 106 includes at least two layers that form a protective bi-layer to provide one or more of mechanical protection (e.g., scratch resistance); weatherability; or chemical resistance. In some examples, the protective bi-layer includes a first protective layer that is closest to the pultrusion substrate, such that the first layer is also referred to as the inner protective layer, and a second layer that is applied to an outer surface or interface of the first or inner protective layer, such that the second layer is also referred to as an outer protective layer.

In an example, the inner protective layer is applied directly to one or more of the outer surfaces of the pultrusion substrate 104 (such as the profile surfaces 134A, 134B in FIGS. 3A and 3B), or the inner protective layer is applied directly to one or more intermediate layers, such as one or more adhesive tie layers, that are disposed between the coated surface of the pultrusion substrate 104 and the protective bi-layer. In an example, the inner protective layer comprises an acrylic-based thermoplastic polymer, such as a polyacrylate (e.g., poly(methyl methacrylate)), and the outer protective layer comprises a polymer blend of an acrylic or acrylic-based thermoplastic polymer (which can be the same as or different from the polymer that forms the inner protective layer) and a fluoropolymer, such as a poly(vinylidene difluoride) (“PVDF”) based polymer or a poly(tetrafluoroethylene) (“PTFE”) based polymer, or combinations thereof.

Once the coating system 114 applies the coating 106, it provides the coated pultrusion article 102, which is further processed by the finishing system 116. In an example, the finishing system 116 includes one or more of a cooling assembly 164 or a pulling mechanism 166. The cooling assembly 164 cools the coated pultrusion article 102, for example by exposing the coated pultrusion article 102 to a cooling medium, such as forced air (e.g., a fan or nozzle providing air at a temperature less than the coated profile), ambient air (e.g., non-forced air), or a cooling liquid, such as in an immersion bath or a cooling liquid sprayed onto the coated profile.

The pulling mechanism 166 pulls the coated pultrusion article 102 from the pultrusion and coating system 100, which in turn will pull the pultrusion substrate 104 from the pultrusion die 112 through the coating system 114, which in turn will pull the feedstock 118 from the feed system 108 through the resin-injection assembly 110 and into the pultrusion die 112. The rate that the pulling mechanism 166 can move the coated pultrusion article 102, pultrusion substrate 104, and feedstock 118 through the pultrusion and coating system 100 can be variable according to a specified production rate, a specific three-dimensional profile 132 of the coated pultrusion article 102 being produced, the materials being used for the pultrusion substrate 104 (e.g., the feedstock 118 and the polymer resin 120), the one or more coating layers, factory conditions, or the like. In various examples, the finishing system 116 can include additional processing apparatuses, such as, but not limited to a cutting mechanism 168 to section the coated pultrusion article 102 to a specified size (e.g. to a predetermined length), a stacking assembly (not shown) to package the cut coated pultrusion articles 102 for shipment, and the like.

In some examples, the pultrusion substrate has one or more surfaces that are relatively smooth or that have a relatively low surface energy, such as a pultruded polyurethane or polyurethane-based substrate. In some examples, a pultrusion and coating system can provide for adequate bonding of a coating material to surfaces that are relatively smooth or have a relatively low-surface energy, or both. In examples, the terms “highly smooth,” “relatively smooth,” and/or “low surface energy” or “relatively low surface energy,” as used herein, can refer to a surface having a water contact angle of less than 65°, such as less than about 60°, for example less than 55°. For example, a particular polyurethane-based pultrusion substrate composition has a water contact angle in the range of about 45° to about 55°, when measured by the contact angle measurement instrument having the model number FTA125, sold by First Ten Angstroms, Inc., Portsmouth, Va., USA. It was found to be difficult to bond coating materials directly to this particular polyurethane-based substrate with the water contact angle of about 45° to about 55°.

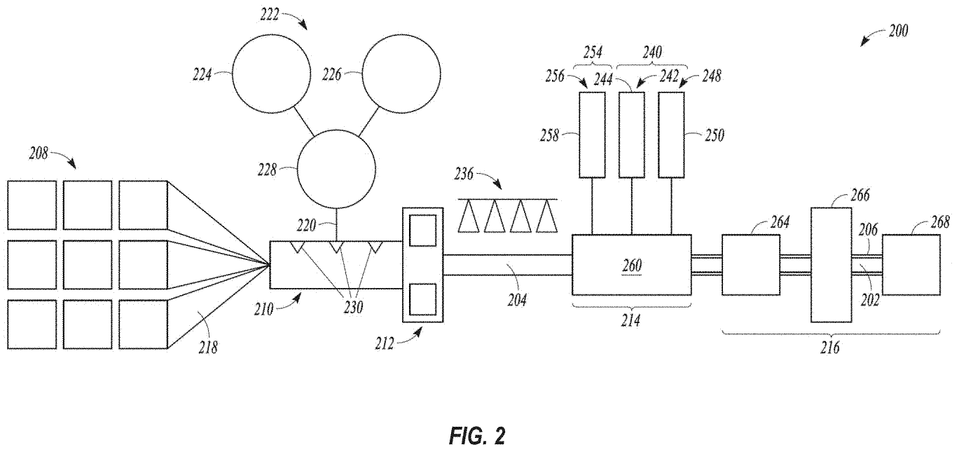

FIG. 2 shows an example of a pultrusion and coating system 200 that is substantially similar to the pultrusion and coating system 100 of FIG. 1 in that the system 200 of FIG. 2 is configured to manufactures a pultruded substrate 204 and applies a coating 206 to the substrate 204 to provide the coated pultrusion article 202, e.g., wherein the coating 206 can be selected to provide one or more improved properties, such as at least one of improved aesthetics, improved color, or improved weatherability compared to the uncoated substrate 204. For example, like the system 100, the pultrusion and coating system 200 of FIG. 2 includes a feed system 208 that provides a feedstock 218 to the system 200, a resin-injection assembly 210, a pultrusion die 212, a coating system 214, and a finishing system 216.

Each of the systems or assemblies 208, 210, 212, and 216 can be substantially similar or identical to that which is described above with respect to the system 100 of FIG. 1. For example, the feed system 208 can deliver a feedstock 218 that is substantially similar or even identical to the feedstock 118 in the system 100, such as by comprising one or more reinforcement structures, such as reinforcing fibers, to which a resin can be applied in order to provide a composite material in the form of the pultrusion substrate 204. The feed system 208 can also deliver a polymer resin 220 to the resin-injection assembly 210, where the polymer resin 220 is contacted with and impregnated into the feedstock 218. For example, the resin-injection assembly 210 can include a resin-mixing system 222 comprising one or more resin storage vessels 224, 226 to store one or more resin constituents. A mixing apparatus 228 can mix resin constituents to form the final desired polymer resin 220, which is then fed to one or more resin nozzles 230, which inject or otherwise apply the polymer resin 220 to the feedstock 218. The resin-injected feedstock 218 is then pulled or otherwise forced through the pultrusion die 212 to shape the resin-injected feedstock 218 into the form of the pultrusion substrate 204. One or more heaters 236 to maintain a temperature of the pultrusion substrate 204, e.g., to improve adhesion of an adhesive material to the pultrusion substrate 204 (as described in more detail below). In alternative embodiments, the system can omit in-line heaters and control the temperature of the pultrusion substrate 204 at the pultrusion die 212 itself, as described above.

The coating 206 is applied onto the pultrusion substrate 204 with the coating system 214. Like the coating system 114 shown in FIG. 1, the coating system 214 in the pultrusion and coating system 100 of FIG. 2 includes a coating-material application assembly 240. The coating-material application assembly 240 includes one or more coating material extruders 242, 248 that each apply a coating material to form one or more corresponding coating material layers. For example, a first coating material extruder 242, comprising a first coating material storage vessel 244, forms a first coating layer, and a second coating material extruder 248, comprising a second coating material storage vessel 250, forms a second coating layer, e.g., on top of the first coating layer. The coating material extruders 242, 248 can each include separate extrusion dies, similar to the first and second coating material dies 146 and 152 shown in FIG. 1, or, as shown in the example of FIG. 2, the first and second coating layers can be coextruded through a coextrusion die 260 (discussed in more detail below).

The primary difference between the system 200 of FIG. 2 and the system 100 of FIG. 1 is that the coating system 214 further includes an adhesive-application assembly 254 so that the coating 206 includes one or more adhesive tie layers disposed between the pultrusion substrate 204 and the other coating-material layers. As used herein, the term “adhesive tie layer” or “tie layer,” can refer to one or more layers of an adhesive material between the pultrusion substrate 204 and the one or more layers of the coating material. The one or more adhesive tie layers provide for coating the one or more layers of the coating material onto a pultrusion substrate 204 that is not generally conducive to being directly coated with the coating material, such as a substrate with relatively smooth surfaces or that has a relatively small surface energy such as polyurethane or polyurethane-based pultrusion substrates. In an example, the one or more adhesive tie layers provide an adhesive strength between the one or more coating layers and the pultrusion substrate 204 that is higher than could be possible if the coating material was applied directly to the pultrusion substrate 204.

The adhesive-application assembly 254 applies one or more adhesive materials onto at least a portion of the profile surfaces on the pultrusion substrate 204 in order to form the one or more adhesive tie layers. In examples where the coating system 214 includes the adhesive-application assembly 254, the coating-material application assembly 240 applies one or more coating materials onto the one or more adhesive tie layers in order to form the one or more layers of the coating 206. In an example, the adhesive-application assembly 254 includes an adhesive material extruder 256 comprising at least one adhesive material storage vessel 258. The at least one adhesive material storage vessel 258 stores the one or more adhesive materials for delivery to an adhesive material die, which can include one or more material dies if needed (e.g., if two or more adhesive tie layers are being applied). The adhesive material die can comprise a separate die for the adhesive material, similar to the separate dies 146, 152 for the separate coating materials from the coating material extruders 142, 148 in FIG. 1, or the adhesive material die can be part of a coextrusion die 260 that is combined with one or both of the dies used for the coating material extruders 242, 248. As shown in the example of FIG. 2, the system 200 includes a single coextrusion die 260 that coextrudes the adhesive material from the adhesive material extruder 256 and the coating materials from the first and second coating material extruders 242, 248 in a single die.

In an example, the adhesive-application assembly 254 includes an adhesive heater (such as a stand-alone heater, a heater as part of the adhesive material die, or a heater in the adhesive material extruder 256. The adhesive heater can heat the one or more adhesive materials to the adhesive-application temperature, described above. In an example, the adhesive-application temperature is at least about the temperature of the pultrusion substrate 204.

In an example, the adhesive-application assembly 254 applies one or more extrudable adhesive materials onto the pultrusion substrate 204 so that the one or more extrudable adhesive materials form one or more adhesive tie layers on the pultrusion substrate 204. In an example, the one or more extrudable adhesive materials include an extrudable thermoplastic adhesive. In some examples, the extrudable thermoplastic adhesive includes, but is not limited to, one or more of: a polyamide; a copolyamide; a block copolymer of a polyamide and a polyester; a thermoplastic polyurethane; an acrylic; a styrenic or butadiene-based block copolymer; a functionalized olefin; a functionalized acrylic; polylactic acid (PLA); or acrylonitrile-butadiene-styrene (ABS). In an example with a polyurethane-based pultrusion substrate 204 and at least one acrylic-based coating layer, copolyamide-based adhesive materials were found to be particularly useful, such as a copolyamide blend, for example a copolyamide blend of two or more different and varying polyamide repeat units. An example of such a copolyamide-based adhesive material is the extrudable polyamide adhesive blend sold under the trade name PLATAMID by Arkema Inc., Colombes, France.

In some cases, an adhesive material comprising a thermoplastic polyurethane was found to be particularly effective for coated articles that are to be used in exterior applications, such as with exterior facing surfaces of window frames or door frames. The thermoplastic polyurethane material used to form the one or more adhesive tie layers can be an aliphatic thermoplastic polyurethane or an aromatic thermoplastic polyurethane. Examples of thermoplastic polyurethanes that can be used for such applications include, but are not limited to, the polyether-based thermoplastic polyurethanes sold under the following trade names: TEXIN by Covestro AG (formerly Bayer MaterialScience), Leverkusen, Germany; KRYSTALGRAM by Huntsman International LLC, The Woodlands, Tex., USA; and PEARLBOND by Lubrizol Advanced Materials, Inc., Brecksville, Ohio, USA.

The finishing system 216 of the pultrusion and coating system 200 can be substantially identical to the finishing system 116 of system 100. For example, the finishing system 116 can include a cooling assembly 264, pulling mechanism 266, and a cutting mechanism 268, which can each be similar or identical to the cooling assembly 164, pulling mechanism 166, and cutting mechanism 168 described above with respect to FIG. 1.

### Coated Pultrusion Articles

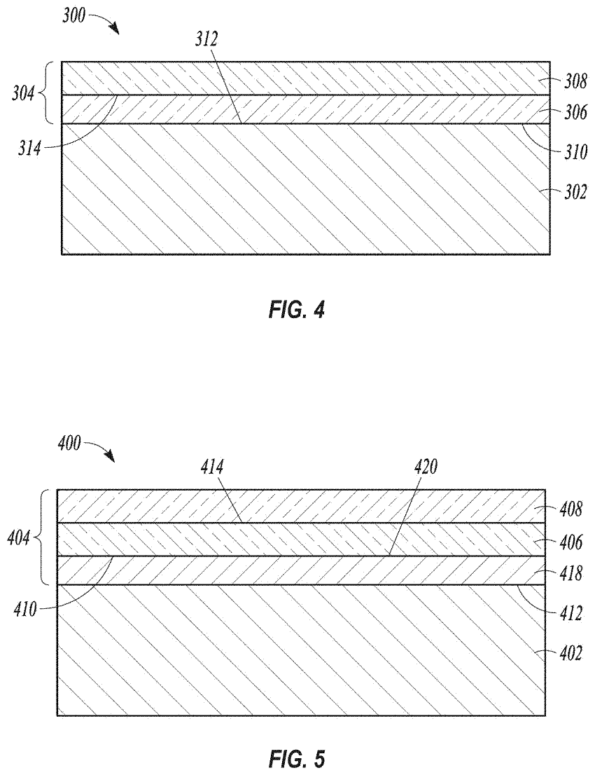

FIGS. 4 and 5 show cross-sectional views of examples of coated pultrusion articles 300, 400 formed by coating a pultrusion substrate 302, 402 with a respective coating 304, 404. The cross-sections of FIGS. 4 and 5 are enlarged to show the structures that make up the example coated pultrusion articles 300 and 400 and are not necessarily drawn to scale.

The coated pultrusion article 300 shown in FIG. 4 is an example of a coated article that is produced by the pultrusion and coating system 100 described above with respect to FIG. 1. The pultrusion substrate 302 in the example coated pultrusion article 300 can comprise a resin injected feedstock that has been shaped, e.g., by pultrusion through a pultrusion die, into a three-dimensional profile having one or more profile surfaces, including, but not limited to coated forms of the example pultrusion substrates 104A and 104B shown in FIGS. 3A and 3B. For purposes of illustration, the coated pultrusion article 300 in FIG. 4 is shown as a cross section of a coated modular patio door sill 102A taken along line 4-4 in FIG. 3A, although this particular section line is shown merely to provide context. Those of skill in the art will appreciate that the example layers of the coated pultrusion article 300 can be from any profile shape, not necessarily the profile 132A shown in FIG. 3A.

In the example coated pultrusion article 300 shown in FIG. 4, the material of the example pultrusion substrate 302 is one onto which the coating materials described below can be directly coated, e.g., the pultrusion substrate 302 has a roughness or high enough surface energy such that the coating material will sufficiently adhere and/or bond directly to an outer surface 312 of the pultrusion substrate 302, such as when the pultrusion substrate 302 is formed using a polyester or polyester-based resin. The example coating 304 comprises a pair of coating layers 306, 308. In an example, the coating layers 306, 308 comprise a protective bi-layer with a first protective layer 306 (also referred to as the inner protective layer 306) having an inner face 310 that is in direct contact with an outer surface 312 of the pultrusion substrate 302. A second protective layer 308 (also referred to as the outer protective layer 308) forms an interface 314 with the inner protective layer 306.

The term “interface,” e.g., in reference to the interface 314 between the inner and outer protective layers 306, 308, can refer to a physical boundary, e.g., between physically distinct layers, or to an amorphous transition zone between different materials (e.g., when two thermopolymer materials are thermally coextruded to form a substantially continuous multi-layer structure). As shown in FIG. 4, the interface 314 opposes the inner face 310 of the inner protective layer 306 and opposes an outer face 316 of the outer protective layer 308, e.g., such that the inner face 310 and the interface 314 are on opposite sides of the inner protective layer 306 and such that the outer face 316 and the interface 314 are on opposite sides of the outer protective layer 308.

In an example, the inner protective layer 306 has a thickness of from about 3 mils (wherein the measurement term “mil,” as used herein, refers to one one-thousandth of an inch, or 0.001 inches) to about 5 mils and the outer protective layer 408 has a thickness of from about 1 mils to about 5 mils. The example coated pultrusion article 300 shown in FIG. 4 can be made using the pultrusion and coating system 100 shown in FIG. 1, e.g., the system 100 with a coating system 114 that includes only a coating-material application assembly 140 without an adhesive material application assembly.

Turning to the example coated pultrusion article 400 shown in FIG. 5, like the coating 304 in FIG. 4, the example coating 404 also comprises a pair of coating layers 406, 408, such as a protective bi-layer with a first protective layer 406 (also referred to as the inner protective layer 406) having an inner face 410 and a second protective layer 408 (also referred to as the outer protective layer 408) that forms an interface 414 with the inner protective layer 406 and that has an outer face 416. Like the interface 314 between the protective layers 306 and 308 in FIG. 4, the interface 414 between the inner and outer protective layers 406, 408, can be a physical boundary, e.g., between physically distinct layers, or to an amorphous transition zone between different materials.

Unlike the material of the pultrusion substrate 302 in FIG. 4, the material of the example pultrusion substrate 402 in FIG. 5 is one onto which the coating materials described below will not reliably bond, e.g., an outer surface 412 of the pultrusion substrate 402 is relatively smooth or has a relatively small surface such that the coating materials do not readily bond to the outer surface 412, such as when the pultrusion substrate 402 is formed using a polyurethane or polyurethane-based resin. Therefore, the coated pultrusion article 400 includes an adhesive tie layer 418 disposed between the pultrusion substrate 402 and the coating layers 406, 408. For example, the adhesive tie layer 418 is deposited directly onto the substrate outer surface 412 while the inner protective layer 406 is deposited onto the adhesive tie layer 418, e.g., such that the inner face 410 of the inner protective layer 406 is in contact with an outer surface 420 of the adhesive tie layer 418. The example coated pultrusion article 400 shown in FIG. 5 can be made using the pultrusion and coating system 200 shown in FIG. 2, e.g., the system 200 with a coating system 214 that includes a coating-material application assembly 240 and an adhesive material application assembly 254. In an example, the adhesive tie layer 418 has a thickness from about 1.5 mils to about 5 mils. In an example, the inner protective layer 406 has a thickness from about 3 mils to about 5 mils and the outer protective layer 408 has a thickness of about 1 mils to about 5 mils.

In an example, the adhesive tie layer 418 comprises an adhesive material that adheres to both the outer surface 412 of the pultrusion substrate 402 and to the material of the inner protective layer 406. In some examples, the adhesive tie layer 418 is formed from an extrudable adhesive material, such as an extrudable thermoplastic adhesive. In some examples, the extrudable thermoplastic adhesive includes, but is not limited to, one or more of: a polyamide; a copolyamide; a block copolymer of a polyamide and a polyester; a thermoplastic polyurethane; an acrylic; a styrenic or butadiene-based block copolymer; a functionalized olefin; a functionalized acrylic; polylactic acid (PLA); or acrylonitrile-butadiene-styrene (ABS). In an example wherein the pultrusion substrate 402 was formed from a polyurethane or polyurethane-based resin and the inner protective layer 406 comprises an acrylic-based coating layer, copolyamide-based adhesive materials were found to be particularly useful, such as a copolyamide blend, for example a copolyamide blend of two or more different and varying polyamide repeat units. An example of such a copolyamide-based adhesive material is the extrudable polyamide adhesive blend sold under the trade name PLATAMID by Arkema Inc., Colombes, France. In another example, the adhesive tie layer 418 comprises a thermoplastic polyurethane adhesive material to bond the protective layer 406 to the pultrusion substrate 402, for example an aliphatic thermoplastic polyurethane or an aromatic thermoplastic polyurethane.

Protective Bilayer

In an example, each coated pultrusion article 300, 400 includes a protective bilayer with an inner protective coating layer 306, 406 (also referred to as the “inner coating layer 306, 406” or simply the “inner layer 306, 406” for brevity) comprising a first protective material and an outer protective coating layer 308, 408 (also referred to as the “outer coating layer 308, 408” or simply the “outer layer 308, 408” for brevity) comprising a second protective coating material. In an example, one or both of the inner layer 306, 406 and the outer layer 308, 408 comprises at least one of: a weather resistant layer, or the like. Additional layers (not shown) beyond the inner layer 306, 406 and the outer layer 308, 408 can be include on each of the coated pultrusion articles 300, 400. For example, the coated pultrusion article 300, 400 can also include one or more of a clear-coat layer, a capping layer, a gloss layer, a texturized outer layer, or a sealant layer.

In an example, the first protective coating material that forms the inner layer 306, 406 is different from the second protective coating material that forms the outer layer 308, 408. For example, the first protective coating material of the inner layer 306, 406 can comprise a composition configured to provide for a first type of protection and the second protective coating material of the outer layer 308, 408 can comprise a composition configured to provide for a second type of protection. Each type of protection (e.g., the first type for the inner layer 306, 406 and the second type for the outer layer 308, 408) can include, but is not limited to, at least one of: UV protection, precipitation protection, temperature protection, chemical resistance, scratch resistance protection, or color fading protection.

In an example that has been found to be particularly conducive for providing weathering and chemical resistance with improved gloss retention and color retention, the inner layer 306, 406 comprises a first thermoplastic material that is an acrylic or acrylic-based polymer, while the outer layer 308, 408 comprises a second thermoplastic material that is a polymer blend of a first thermoplastic polymer and a second thermoplastic polymer, wherein the first thermoplastic polymer comprises a fluoropolymer (e.g., that consists of or substantially principally comprises a fluoropolymer) and wherein the second thermoplastic polymer comprises an acrylic or acrylic-based polymer (e.g., that consists of or substantially entirely comprises an acrylic or acrylic-based polymer). One or both of the inner layer 306, 406 and the outer layer 308, 408 may optionally include one or more additives such as colorant or dye and one or more stabilizer compounds such as an antioxidant or a UV-resistant compound.

As used herein, the term “acrylic or acrylic-based polymer” refers to a polymer formed from polymerized monomer units that are derived from acrylic acid including, but not limited to: an ester derived from acrylic acid (often referred to as an acrylate) (e.g., poly(methyl methacrylate) or “PMMA” or poly(methyl acrylate) or “PMA”), or an acyl compound derived from acrylic acid, such as poly(acryloyl), or a polyacetyl. As used herein, the term “fluoropolymer” refers to an organic polymer wherein at least one of the monomer units that are polymerized to form the fluoropolymer include at least one fluorine atom. In some examples, the fluorocarbon can include, but is not limited to, fluorovinyl-based monomer units, hydrofluorocarbon-based monomer units, chlorofluorocarbon-based monomer units, perfluorinated alkene-based monomer units, perfluoroether-based monomer units, and perfluorocycloalkene-based monomer units. Examples of polymerized monomer units that can form at least a portion of the fluoropolymer include, but are not limited to monomer units derived from a hydrofluoro-olefin and monomer units derived from a perfluorinated alkene.

As used herein, the term “hydrofluoro-olefin” refers to an unsaturated organic compound that includes carbon, hydrogen, and fluorine that comprises at least one carbon-carbon double bond, as well as substituted forms of such compounds. A non-limiting example of polymerized monomer units derived from a hydrofluoro-olefin are monomer units derived from vinylidene difluoride (also referred to herein as “VDF”) or commonly substituted versions of VDF. A non-limiting example of a polymer formed from polymerized monomer units derived from a hydrofluoro-olefin is the polymer having the IUPAC name poly(1,1-difluoroethylene) (also referred to by the trade name “KYNAR” as sold by Arkema S. A., Colombes, France, and which will also be referred to herein as “poly(vinylidene difluoride)” or “PVDF”).

As used herein, the term “perfluorinated alkene” refers to an unsaturated organic compound that includes only carbon and fluorine atoms with only C—C bonds and C—F bonds and at least one carbon-carbon double bone, as well as substituted forms of such compounds. A non-limiting example of polymerized monomer units derived from a perfluorinated alkene are monomer units derived from tetrafluoroethylene (also referred to herein as “TFE”) or commonly substituted versions of TFE. A non-limiting example of a polymer formed from polymerized units derived from a perfluorinated alkene is the polymer having the IUPAC name poly(1,1,2,2-tetrafluoroethylene) (also referred to by the trade name “TEFLON” as sold by The Chermours Co., Wilmington, Del., USA, and which will also be referred to herein as “poly(tetrafluoroethylene)” or “PTFE”), or combinations thereof. Another perfluorinated alkene that is often used in fluoropolymers is hexafluoropropylene (C₃F₆, also referred to herein as “HFP”), although HFP is most commonly used as a comonomer in combination with another copolymerized monomer unit (such as with VDF monomer units to form a PVDF-based copolymer, or with TFE monomer units to form a PTFE-based copolymer) rather than as the monomer in a homopolymer.

As used herein, the term “substituted” can refer to any organic compound wherein one or more hydrogen atoms or one or more moieties can be replaced with a different elemental atom or moiety, including those substituted with one or more or any combination of: hydrogen, chlorine or another halide, an alkyl group (including a cycloalkyl group), aryl group, alkoxy group, aryloxy group, aralkyloxy group, oxo(carbonyl) group, carboxyl group including a carboxylic acid, carboxylate, and a carboxylate ester; a sulfur-containing group such as an alkyl and aryl sulfide; and other heteroatom-containing groups. Non-limiting examples of further organic substitution groups include OR, OOR, OC(O)N(R)₂, CN, CF₃, OCF₃, R, C(O), methylenedioxy, ethylenedioxy, N(R)₂, SR, SOR, SO₂R, SO₂N(R)₂, SO₃R, C(O)R, C(O)C(O)R, C(O)CH₂C(O)R, C(S)R, C(O)OR, OC(O)R, C(O)N(R)₂, OC(O)N(R)₂, C(S)N(R)₂, (CH₂)₀₋₂N(R)C(O)R, (CH₂)₀₋₂N(R)N(R)₂, N(R)N(R)C(O)R, N(R)N(R)C(O)OR, N(R)N(R)CON(R)₂, N(R)SO₂R, N(R)SO₂N(R)₂, N(R)C(O)OR, N(R)C(O)R, N(R)C(S)R, N(R)C(O)N(R)₂, N(R)C(S)N(R)₂, N(COR)COR, N(OR)R, C(═NH)N(R)₂, C(O)N(OR)R, or C(═NOR)R, wherein R can be hydrogen (in examples that include other carbon atoms) or a carbon-based moiety, wherein the carbon-based moiety can itself be further substituted.

The inventors have found that including a specified amount of the fluoropolymer, such as a PVDF based polymer or a PTFE based polymer or a combination of the two, in a blend with an acrylic or acrylic-based polymer to form the outer layer 308, 408 provides for particularly good results in terms of weatherability and chemical resistance for the overall coated pultrusion article 300, 400 that were beyond that which was expected. In prior examples where an acrylic-acrylic/fluoride bilayer was used, the inventors hypothesized that an outer layer 308, 408 comprising from about 25 wt. % to about 50 wt. % of the fluoropolymer, with the balance of the outer layer 308, 408 (e.g., from about 50 wt. % to about 75 wt. %) comprising the acrylic or acrylic-based polymer was believed to be an optimal amount of the fluoropolymer. See, e.g., U.S. patent application Ser. No. 16/379,164, which was published on Oct. 10, 2019 as U.S. Patent Application Publication No. 2019/0308396 A1, whose inventors are the same as the present application.

The present inventors have now found that, contrary to their earlier patent application (U.S. Pub. No. 2019/0308396A1), the outer layer 308, 408 can have a substantially higher percentage of the fluoropolymer than was previously thought to be effective, e.g., wherein a polymer blend that is used to form the outer layer 308, 408 comprises at last 60 wt. % of the fluoropolymer, such as at least about 75 wt. % of the fluoropolymer, and in a preferred example, wherein the outer layer 308, 408 comprises at least about 90 wt. % of the fluoropolymer. The inventors have found that when the bilayer is formed with this particular combination of the inner layer 306, 406 formed from an acrylic or acrylic-based polymer inner and the outer layer 308, 408 formed from a polymer blend of a fluoropolymer and an acrylic or acrylic-based polymer wherein the outer layer 308, 408 has such a high amount of the fluoropolymer, then the protective bilayer comprising the inner layer 306, 406 and the outer layer 308, 408 can provide for better weatherability and chemical resistance as compared to a comparable coating wherein the outer layer 308, 408 has a lower relative amount of the fluoropolymer while still having adequate adhesion to underlying inner layer 306, 406 (as discussed below in the EXAMPLES section).

For example, in the inventors previous patent application (U.S. Pub. No. 2019/0308396A1), the inventors had believed that if the polymer blend of the outer layer had a very high percentage of PVDF, that it would not adequately adhere to an acrylic-based inner protective layer such that it was believed that a relatively high-percentage PVDF outer layer would tend to delaminate and fail. It was also believed that when the polymer blend of the outer layer had too high of a percentage of the fluoropolymer that the outer layer would be crystalline or semi-crystalline when in the solid state, wherein crystalline or semi-crystalline outer protective layers had been found to result in less robust chemical or weathering protection (e.g., an overall protective coating that would be less able to withstand long-term weather or chemical exposure than an outer layer formed from an acrylic/fluoride blend that results in an amorphous solid). The inventors also believed that an outer layer formed from an acrylic/fluoride-polymer blend with a relative amount of the fluoropolymer at or below about 50 wt. % so that the outer layer is formed from an amorphous solid would be more resistant to mechanical damage (e.g., from scratching), more resistant to weathering (e.g., is better able to withstand longer periods of exposure and to more extreme weather conditions with less change in appearance, such as less color fading and less loss in glossiness), and more resistant to chemical exposure (e.g., is better able to withstand exposure to certain chemicals) than when the outer layer comprises a relative amount of the fluoropolymer that is higher than 50 wt. %.

In some examples, the protective bi-layer described above, e.g., with the inner layer 306, 406 comprising an acrylic or acrylic-based polymer and the outer layer 308, 408 comprising a specified blend of a fluoropolymer and an acrylic or acrylic-based polymer that is able to pass the highest weathering performance standards. In some examples, the protective bilayer described herein is able to pass the American Architectural Manufacturers Association (“AAMA”) 625 Voluntary Specification, including, but not limited to, achieving color retention with a delta E of 5 or less and a gloss retention of at least 50% gloss retention after 10 years of weathering. The higher percentage of the fluoropolymer in the outer layer 308, 408 was able to withstand weathering for a longer period of time and/or with more color retention and/or more gloss retention. The addition of the relatively high amount of the fluoropolymer to the polymer blend with the acrylic or acrylic-based polymer for use in the outer layer 308, 408 of the bilayer was also able to better withstand exposure to typical cleaning chemicals compared to a bilayer wherein the outer layer has a lower relative amount of the fluoropolymer. Cleaning chemicals are known to cause stress cracking, delamination, or both, in coated pultrusion articles. The higher relative amount of the fluoropolymer in the outer layer 308, 408 of the bilayer coating 304, 404 of the coated articles 300, 400 is particularly helpful in providing for longer-term resistance to cleaning chemicals without substantial cracking or delamination.

In an example, the fluoropolymer forms from about 50 wt. % to about 98 wt. % of the polymer blend that is extruded to form the outer layer 308, 408, with the remaining balance of the outer layer 308, 408 (e.g., from about 2 wt. % to about 50 wt. %) comprising an acrylic or acrylic-based polymer. In another example, the fluoropolymer makes up from about 60 wt. % to about 95 wt. % of the polymer blend that forms the outer layer 308, 408, such as from about 70 wt. % to about 92.5 wt. %, for example from about 80 wt. % to about 90 wt. % of the polymer blend that forms the outer layer 308, 408. In an example, the outer layer 308, 408 can comprise an effective amount of no more than about 5 wt. % to 8 wt. %, of additives such as antioxidants, ultraviolet-resistant additives, colorants or dyes, or other additives that are typical for protective coatings on pultrusion articles. In an example, the remaining balance of the polymer blend that forms the outer layer 308, 408 (e.g., from about 2 wt. % to about 50 wt. %) comprises an acrylic or acrylic-based polymer, which can be the same acrylic or acrylic-based polymer as that which makes up the inner layer 306, 406 or can be a different acrylic or acrylic-based polymer. In an example, the acrylic or acrylic-based polymer makes up from about 5 wt. % to about 40 wt. % of the polymer blend, such as from about 7.5 wt. % to about 30 wt. %, for example from about 10 wt. % to about 20 wt. % of the polymer blend that forms the outer layer 308, 408.

In an example, the fluoropolymer of the polymer blend makes up at least about 50 wt. % of the outer protective layer, for example at least about 55 wt. %, at least about 60 wt. %, at least about 61 wt. %, at least about 62 wt. %, at least about 63 wt. %, at least about 64 wt. %, at least about 65 wt. %, at least about 66 wt. %, at least about 67 wt. %, at least about 68 wt. %, at least about 69 wt. %, at least about 70 wt. %, at least about 71 wt. %, at least about 72 wt. %, at least about 73 wt. %, at least about 74 wt. %, at least about 75 wt. %, at least about 76 wt. %, at least about 77 wt. %, at least about 78 wt. %, at least about 79 wt. %, at least about 80 wt. %, at least about 81 wt. %, at least about 82 wt. %, at least about 83 wt. %, at least about 84 wt. %, at least about 85 wt. %, at least about 86 wt. %, at least about 87 wt. %, at least about 88 wt. %, at least about 89 wt. %, at least about 90 wt. %, at least about 91 wt. %, at least about 92 wt. %, at least about 92.5 wt. %, at least about 93 wt. %, at least about 94 wt. %, at least about 95 wt. %, at least about 96 wt. %, at least about 97 wt. %, at least about 97.5 wt. %, at least about 98 wt. %, at least about 99 wt. %, at least about 99.5 wt. %, and at least about 99.9 wt. % of the outer protective layer is formed from the fluoropolymer, with the acrylic or acrylic-based polymer being the primary component taking up the majority of the balance for each weight percentage of the fluoropolymer, if not all or substantially all of the balance for each percentage of the fluoropolymer.

In particular, when the primary fluorocompound that is used to form a majority of the fluoride-containing portion of the polymer blend is PVDF or another fluoropolymer formed from polymerized monomer units derived from VDF or a substituted vinylidene fluoride monomer, then the resulting outer layer 308, 408 at the bilayer coating 304, 404 comprising it tend to be particularly able to exhibit weathering and chemical resistance. Therefore, in an example, a polymer formed from polymerized monomer units derived from a hydrofluoro-olefin, and in particular monomer units derived from VDF or a substituted vinylidene fluoride, makes up at least about 50 wt. % of the total fluoropolymer of the polymer blend (e.g., the first thermoplastic polymer that is mixed with the second thermoplastic polymer which comprises the acrylic or acrylic-based polymer to form the polymer blend that is extruded to form the outer layer 308, 408), such as at least about 55 wt. %, for example at least about 60 wt. %, at least about 61 wt. %, at least about 62 wt. %, at least about 63 wt. %, at least about 64 wt. %, at least about 65 wt. %, at least about 66 wt. %, at least about 67 wt. %, at least about 68 wt. %, at least about 69 wt. %, at least about 70 wt. %, at least about 71 wt. %, at least about 72 wt. %, at least about 73 wt. %, at least about 74 wt. %, at least about 75 wt. %, at least about 76 wt. %, at least about 77 wt. %, at least about 78 wt. %, at least about 79 wt. %, at least about 80 wt. %, at least about 81 wt. %, at least about 82 wt. %, at least about 83 wt. %, at least about 84 wt. %, at least about 85 wt. %, at least about 86 wt. %, at least about 87 wt. %, at least about 88 wt. %, at least about 89 wt. %, at least about 90 wt. %, at least about 91 wt. %, at least about 92 wt. %, at least about 93 wt. %, at least about 94 wt. %, at least about 95 wt. %, at least about 96 wt. %, at least about 97 wt. %, at least about 97.5 wt. %, at least about 98 wt. %, at least about 98.5 wt. %, at least about 99 wt. %, at least about 99.5 wt. %, at least about 99.75 wt. %, at least about 99.9 wt. %, at least about 99.95 wt. %, at least about 99.99 wt. %, at least about 99.999 wt. %, at least about 99.9999 wt. %, or in some examples all 100 wt. % of the fluoropolymer portion of the polymer blend for the outer layer 308, 408. If another fluoropolymer is used in addition to the PVDF or the polymer formed from polymerized monomer units comprising a hydrofluoro-olefin other than VDF, the most commonly used other fluoropolymer would be a polymer formed from polymerized monomer units comprising a perfluorinated alkene, and in particular those derived from TFE or a substituted TFE, e.g., PTFE. In an example, the fluoropolymer can include about 0.0001 wt. % PTFE or a different polymer formed from polymerized monomer units comprising a different perfluorinated alkene, such as about 0.001 wt. %, about 0.01 wt. %, about 0.1 wt. %, about 0.5 wt. %, about 0.75 wt. %, about 0.9 wt. %, about 1 wt. %, about 1.1 wt. %, about 1.2 wt. %, about 1.3 wt. %, about 1.4 wt. %, about 1.5 wt. %, about 1.6 wt. %, about 1.7 wt. %, about 1.8 wt. %, about 1.9 wt. %, about 2 wt. %, about 2.1 wt. %, about 2.2 wt. %, about 2.3 wt. %, about 2.4 wt. %, about 2.5 wt. %, about 2.6 wt. %, about 2.7 wt. %, about 2.8 wt. %, about 2.9 wt. %, about 3 wt. %, about 3.1 wt. %, about 3.2 wt. %, about 3.3 wt. %, about 3.4 wt. %, about 3.5 wt. %, about 3.6 wt. %, about 3.7 wt. %, about 3.8 wt. %, about 3.9 wt. %, about 4 wt. %, about 4.1 wt. %, about 4.2 wt. %, about 4.3 wt. %, about 4.4 wt. %, about 4.5 wt. %, about 4.6 wt. %, about 4.7 wt. %, about 4.8 wt. %, about 4.9 wt. %, about 5 wt. %, about 5.1 wt. %, about 5.2 wt. %, about 5.3 wt. %, about 5.4 wt. %, about 5.5 wt. %, about 5.6 wt. %, about 5.7 wt. %, about 5.8 wt. %, about 5.9 wt. %, about 6 wt. %, about 6.1 wt. %, about 6.2 wt. %, about 6.3 wt. %, about 6.4 wt. %, about 6.5 wt. %, about 6.6 wt. %, about 6.7 wt. %, about 6.8 wt. %, about 6.9 wt. %, about 7 wt. %, about 7.1 wt. %, about 7.2 wt. %, about 7.3 wt. %, about 7.4 wt. %, about 7.5 wt. %, about 7.6 wt. %, about 7.7 wt. %, about 7.8 wt. %, about 7.9 wt. %, about 8 wt. %, about 8.1 wt. %, about 8.2 wt. %, about 8.3 wt. %, about 8.4 wt. %, about 8.5 wt. %, about 8.6 wt. %, about 8.7 wt. %, about 8.8 wt. %, about 8.9 wt. %, about 9 wt. %, about 9.1 wt. %, about 9.2 wt. %, about 9.3 wt. %, about 9.4 wt. %, about 9.5 wt. %, about 9.6 wt. %, about 9.7 wt. %, about 9.8 wt. %, about 9.9 wt. %, about 10 wt. %, about 10.1 wt. %, about 10.2 wt. %, about 10.3 wt. %, about 10.4 wt. %, about 10.5 wt. %, about 10.6 wt. %, about 10.7 wt. %, about 10.8 wt. %, about 10.9 wt. %, about 11 wt. %, about 11.1 wt. %, about 11.2 wt. %, about 11.3 wt. %, about 11.4 wt. %, about 11.5 wt. %, about 11.6 wt. %, about 11.7 wt. %, about 11.8 wt. %, about 11.9 wt. %, about 12 wt. %, about 12.1 wt. %, about 12.2 wt. %, about 12.3 wt. %, about 12.4 wt. %, about 12.5 wt. %, about 12.6 wt. %, about 12.7 wt. %, about 12.8 wt. %, about 12.9 wt. %, about 13 wt. %, about 13.1 wt. %, about 13.2 wt. %, about 13.3 wt. %, about 13.4 wt. %, about 13.5 wt. %, about 13.6 wt. %, about 13.7 wt. %, about 13.8 wt. %, about 13.9 wt. %, about 14 wt. %, about 14.1 wt. %, about 14.2 wt. %, about 14.3 wt. %, about 14.4 wt. %, about 14.5 wt. %, about 14.6 wt. %, about 14.7 wt. %, about 14.8 wt. %, about 14.9 wt. %, about 15 wt. %, about 15.1 wt. %, about 15.2 wt. %, about 15.3 wt. %, about 15.4 wt. %, about 15.5 wt. %, about 15.6 wt. %, about 15.7 wt. %, about 15.8 wt. %, about 15.9 wt. %, about 16 wt. %, about 16.1 wt. %, about 16.2 wt. %, about 16.3 wt. %, about 16.4 wt. %, about 16.5 wt. %, about 16.6 wt. %, about 16.7 wt. %, about 16.8 wt. %, about 16.9 wt. %, about 17 wt. %, about 17.1 wt. %, about 17.2 wt. %, about 17.3 wt. %, about 17.4 wt. %, about 17.5 wt. %, about 17.6 wt. %, about 17.7 wt. %, about 17.8 wt. %, about 17.9 wt. %, about 18 wt. %, about 18.1 wt. %, about 18.2 wt. %, about 18.3 wt. %, about 18.4 wt. %, about 18.5 wt. %, about 18.6 wt. %, about 18.7 wt. %, about 18.8 wt. %, about 18.9 wt. %, about 19 wt. %, about 19.1 wt. %, about 19.2 wt. %, about 19.3 wt. %, about 19.4 wt. %, about 19.5 wt. %, about 19.6 wt. %, about 19.7 wt. %, about 19.8 wt. %, about 19.9 wt. %, and about 20 wt. %, or any range of values using any two of these values as endpoints of the range.

The remainder of the polymer blend that forms the outer layer 308, 408 (e.g., the second thermoplastic polymer that is mixed with the one or more fluoropolymers of the first thermoplastic polymer to form the polymer blend) comprises an acrylic or acrylic-based polymer, which can be the same acrylic or acrylic-based polymer that is used to form the inner layer 306, 406 or it can be a different acrylic or acrylic-based polymer. In an example, the outer layer 308, 408 comprises about 0.01 wt. % of the outer protective layer, for example about 0.05 wt. %, about 1 wt. %, about 2 wt. %, about 2.5 wt. %, about 3 wt. %, about 4 wt. %, about 5 wt. %, about 6 wt. %, about 7 wt. %, about 7.5 wt. %, about 8 wt. %, about 9 wt. %, about 10 wt. %, about 11 wt. %, about 12 wt. %, about 13 wt. %, about 14 wt. %, about 15 wt. %, about 16 wt. %, about 17 wt. %, about 18 wt. %, about 19 wt. %, about 20 wt. %, about 21 wt. %, about 22 wt. %, about 23 wt. %, about 24 wt. %, about 25 wt. %, about 26 wt. %, about 27 wt. %, about 28 wt. %, about 29 wt. %, about 30 wt. %, about 31 wt. %, about 32 wt. %, about 33 wt. %, about 34 wt. %, about 35 wt. %, about 36 wt. %, about 37 wt. %, about 38 wt. %, about 39 wt. %, or about 40 wt. % of the outer protective layer, or any range of values using any two of these values as endpoints of the range.

Functionalized Copolymerization

In an example, one or more of the polymers that form the fluoropolymer portion of the polymer blend that forms the outer layer 308, 408 can be a copolymer comprising one or more additional polymerized monomer units (which will also be referred to herein as the “polymerized comonomer units”) in addition to the primary monomer units described above (e.g., vinylidene difluoride (“VDF”) or another hydrofluoro-olefin for a PVDF based polymer or tetrafluoroethylene (“TFE”) or another perfluorinated alkene for a PTFE based polymer). In some examples, the polymerized comonomer units may be referred to as “polymerized second monomer units” or “polymerized second comonomer units” in order to clarify the difference between the comonomer units and the primary polymerized monomer units, which may be referred to as the “polymerized first monomer units” or the “polymerized primary monomer units.”

Each of the one or more polymerized comonomer units can be selected to impart one or more physical or chemical properties to the fluoropolymer that results from copolymerization of the polymerized primary polymer units and the secondary polymerized copolymer units. For example, as mentioned above, the weatherability and/or the chemical resistance of the coating 304, 404 can depend on the relative crystallinity of the solid outer layer 308, 408, i.e., on the degree to which the outer layer 308, 408 is an amorphous polymer or a crystalline polymer. As is also mentioned above, a polymer that is pure polyvinylidene fluoride or that has a high mole % of the VDF monomer units tends to have a high crystallinity. PVDF-based polymers with high crystallinity tend to have less weatherability and chemical resistance. Therefore, in an example, the one or more polymerized comonomer units for inclusion in the fluoropolymer of the polymer blend can include a comonomer compound that will tend to reduce the crystallinity of the resulting fluoropolymer resin. In an example, after the inclusion of the one or more comonomer units into the fluoropolymer backbone, the resulting fluoropolymer can have a lower crystallinity than the fluoropolymer without the one or more comonomer units.

Pure poly(vinylidene difluoride) resins or those with high VDF mole percentages tend to be somewhat hard and not very pliable, making them difficult to extrude as a thin film layer. Therefore, in an example, the one or more polymerized comonomer units that can be included in the fluoropolymer of the polymer blend can include a comonomer compound that can make the resulting polymer resin softer and/or more pliable so that the polymer resin is easier to extrude into a thin film for use as the outer layer 308, 408. In some examples, the reduction in crystallinity for the resulting fluoropolymer resin can also tend to provide for the softening and increased pliability.

In an example, comonomer units that provide for both the reduced crystallinity and the increased softness and/or pliability when copolymerized with VDF monomer units are polymerized comonomer units derived from hexafluoropropylene (C₃F₆, also referred to herein as “HFP”). The resulting fluoropolymer can have the general chemical formula [A]:

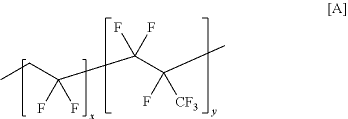

wherein “x” is the relative molar amount of the VDF monomer units within the fluoropolymer chain of formula [A] and “y” is the relative molar amount of the HFP comonomer units within the polymer chain of formula [A]. Other comonomer units that can copolymerized with the VDF monomer units include, but are not limited to, chlorotrifluoroethylene (C₂ClF₃, also referred to herein as “CTFE”) or tetrafluoroethylene (C₂F₄, or “TFE”).

In an example, the relative amount of the polymerized comonomer units derived from HFP in the fluoropolymer (e.g., y in chemical formula [A]) is from about 0.5 mol. % to about 15 mol. %, such as from about 1 mol. % to about 10 mol. %, for example from about 2.5 mol. % to about 7 mol. %, such as from about 4 mol. % to about 6 mol. %, for example from about 4.5 mol. % to about 5 mol. % HFP, e.g., from about 4.4 mol. % HFP to about 4.6 mol. % HFP, such as from about 4.5 mol. % HFP to about 4.55 mol. % HFP, such as about 4.52 mol. % HFP.

In an example, the relative amount of the polymerized comonomer units, e.g., those that can provide for reduced crystallinity and/or increased softness or pliability such as comonomer units derived from HFP, in the final fluoropolymer is about 20 mol. %, for example about 19.5 mol. %, about 19 mol. %, about 18.5 mol. %, about 18 mol. %, about 17.5 mol. %, about 17 mol. %, about 16.5 mol. %, about 16 mol. %, about 15.5 mol. %, about 15 mol. %, about 14.9 mol. %, about 14.8 mol. %, about 14.7 mol. %, about 14.6 mol. %, about 14.5 mol. %, about 14.4 mol. %, about 14.3 mol. %, about 14.2 mol. %, about 14.1 mol. %, about 14 mol. %, about 13.9 mol. %, about 13.8 mol. %, about 13.7 mol. %, about 13.6 mol. %, about 13.5 mol. %, about 13.4 mol. %, about 13.3 mol. %, about 13.2 mol. %, about 13.1 mol. %, about 13 mol. %, about 12.9 mol. %, about 12.8 mol. %, about 12.7 mol. %, about 12.6 mol. %, about 12.5 mol. %, about 12.4 mol. %, about 12.3 mol. %, about 12.2 mol. %, about 12.1 mol. %, about 12 mol. %, about 11.9 mol. %, about 11.8 mol. %, about 11.7 mol. %, about 11.6 mol. %, about 11.5 mol. %, about 11.4 mol. %, about 11.3 mol. %, about 11.2 mol. %, about 11.1 mol. %, about 11 mol. %, about 10.9 mol. %, about 10.8 mol. %, about 10.7 mol. %, about 10.6 mol. %, about 10.5 mol. %, about 10.4 mol. %, about 10.3 mol. %, about 10.2 mol. %, about 10.1 mol. %, about 10 mol. %, about 9.95 mol. %, about 9.9 mol. %, about 9.85 mol. %, about 9.8 mol. %, about 9.75 mol. %, about 9.7 mol. %, about 9.65 mol. %, about 9.6 mol. %, about 9.55 mol. %, about 9.5 mol. %, about 9.45 mol. %, about 9.4 mol. %, about 9.35 mol. %, about 9.3 mol. %, about 9.25 mol. %, about 9.2 mol. %, about 9.15 mol. %, about 9.1 mol. %, about 9.05 mol. %, about 9 mol. %, about 8.95 mol. %, about 8.9 mol. %, about 8.85 mol. %, about 8.8 mol. %, about 8.75 mol. %, about 8.7 mol. %, about 8.65 mol. %, about 8.6 mol. %, about 8.55 mol. %, about 8.5 mol. %, about 8.45 mol. %, about 8.4 mol. %, about 8.35 mol. %, about 8.3 mol. %, about 8.25 mol. %, about 8.2 mol. %, about 8.15 mol. %, about 8.1 mol. %, about 8.05 mol. %, about 8 mol. %, about 7.95 mol. %, about 7.9 mol. %, about 7.85 mol. %, about 7.8 mol. %, about 7.75 mol. %, about 7.7 mol. %, about 7.65 mol. %, about 7.6 mol. %, about 7.55 mol. %, about 7.5 mol. %, about 7.45 mol. %, about 7.4 mol. %, about 7.35 mol. %, about 7.3 mol. %, about 7.25 mol. %, about 7.2 mol. %, about 7.15 mol. %, about 7.1 mol. %, about 7.05 mol. %, about 7 mol. %, about 6.95 mol. %, about 6.9 mol. %, about 6.85 mol. %, about 6.8 mol. %, about 6.75 mol. %, about 6.7 mol. %, about 6.65 about 6.6 mol. %, about 6.55 about 6.5 mol. %, about 6.45 about 6.4 mol. %, about 6.35 about 6.3 mol. %, about 6.25 about 6.2 mol. %, about 6.15 about 6.1 mol. %, about 6.05 about 6 mol. %, about 5.95 about 5.9 mol. %, about 5.85 about 5.8 mol. %, about 5.75 about 5.7 mol. %, about 5.65 about 5.6 mol. %, about 5.55 mol. %, about 5.5 mol. %, about 5.45 mol. %, about 5.4 mol. %, about 5.35 mol. %, about 5.3 mol. %, about 5.25 mol. %, about 5.2 mol. %, about 5.15 mol. %, about 5.1 mol. %, 5.05 mol. %, about 5 mol. %, about 4.95 mol. %, about 4.9 mol. %, about 4.85 mol. %, about 4.8 mol. %, about 4.75 mol. %, about 4.7 mol. %, about 4.65 mol. %, about 4.6 mol. %, about 4.59 mol. %, about 4.58 mol. %, about 4.57 mol. %, about 4.56 mol. %, about 4.55 mol. %, about 4.54 mol. %, about 4.53 mol. %, about 4.52 mol. %, about 4.51 mol. %, about 4.5 mol. %, about 4.49 mol. %, about 4.48 mol. %, about 4.47 mol. %, about 4.46 mol. %, about 4.45 mol. %, about 4.44 mol. %, about 4.43 mol. %, about 4.42 mol. %, about 4.41 mol. %, about 4.4 mol. %, about 4.39 mol. %, about 4.38 mol. %, about 4.37 mol. %, about 4.36 mol. %, about 4.35 mol. %, about 4.34 mol. %, about 4.33 mol. %, about 4.32 mol. %, about 4.31 mol. %, about 4.3 mol. %, about 4.29 mol. %, about 4.28 mol. %, about 4.27 mol. %, about 4.26 mol. %, about 4.25 mol. %, about 4.2 mol. %, about 4.15 mol. %, about 4.1 mol. %, about 4.05 mol. %, about 4 mol. %, about 3.95 mol. %, about 3.9 mol. %, about 3.85 mol. %, about 3.8 mol. %, about 3.75 mol. %, about 3.7 mol. %, about 3.65 mol. %, about 3.6 mol. %, about 3.55 mol. %, about 3.5 mol. %, about 3.45 mol. %, about 3.4 mol. %, about 3.35 mol. %, about 3.3 mol. %, about 3.25 mol. %, about 3.2 mol. %, about 3.15 mol. %, about 3.1 mol. %, about 3.05 mol. %, about 3 mol. %, about 2.95 mol. %, about 2.9 mol. %, about 2.85 mol. %, about 2.8 mol. %, about 2.75 mol. %, about 2.7 mol. %, about 2.65 mol. %, about 2.6 mol. %, about 2.55 mol. %, about 2.5 mol. %, about 2.45 mol. %, about 2.4 mol. %, about 2.35 mol. %, about 2.3 mol. %, about 2.25 mol. %, about 2.2 mol. %, about 2.15 mol. %, about 2.1 mol. %, about 2.05 mol. %, about 2 mol. %, about 1.9 mol. %, about 1.8 mol. %, about 1.7 mol. %, about 1.6 mol. %, about 1.5 mol. %, about 1.4 mol. %, about 1.3 mol. %, about 1.2 mol. %, about 1.1 mol. %, about 1 mol. %, about 0.9 mol. %, about 0.8 mol. %, about 0.7 mol. %, about 0.6 mol. %, about 0.5 mol. %, about 0.4 mol. %, about 0.3 mol. %, about 0.25 mol. %, about 0.2 mol. %, or about 0.1 mol. % of the final fluoropolymer.

Other factors that may be important for the final fluoropolymer and/or the polymer blend made up of the fluoropolymer blended with the acrylic or acrylic-based polymer include, but are not limited to: processability at a specified extrusion temperature and pressure; coating performance (e.g., wettability of the extruded molten polymer on the outer surface of the acrylic or acrylic-based polymer of the inner layer 306, 406); color of the final set outer layer 308, 408; gloss of the final set outer layer 308, 408; water contact angle (e.g., as a measure of the surface free energy of the outer layer 308, 408); adhesion bonding of the polymer blend to the acrylic or acrylic-based polymer of the inner layer 306, 406 (e.g., as measured in terms of positester adhesion and scrape adhesion); adhesion bonding of a sealant or other capping layer material onto the outer surface of the outer layer 308, 408; compatibility of the sealant or other capping layer material with the polymer blend of the outer layer 308, 408; resistance to scratching (e.g., as measured by a “five finger” scratch test); impact resistance; chemical resistance; and weatherability resistance (e.g., as measured by a boil test, a boil anneal test, and a thermal and humidity cycle test).

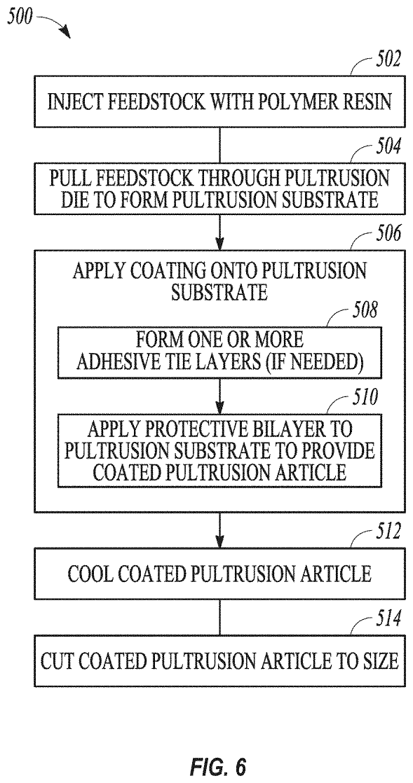

FIG. 6 is a diagram of an example method 500 for coating a substrate, such as a pultrusion substrate, to form a coated article. The method includes, at step 502, injecting a feedstock with a polymer resin to provide a resin-injected feedstock. In an example, resin-injecting the feedstock 502 can include aligning the feedstock prior to injecting the polymer resin, such as by aligning the feedstock from one or more roving.

In an example, the feedstock can comprise one or more reinforcing structures, such as one or more reinforcing fibers. The polymer resin can comprise a composition of one or more resin components. The one or more resin components can be mixed, for example with a mixing apparatus, to form the polymer resin. In an example, the polymer resin comprises a polyester-based resin. In another example, the polymer resin comprises a polyurethane-based resin, such as a resin formed from a mixture of one or more polyols and one or more isocyanates. Resin-injecting the feedstock 502 can be performed by one or more injections nozzles, such as the resin nozzles 130, 230 described above. In an example. Resin-injecting the feedstock 502 can be performed, for example, with the resin-injection assembly 110, 210 described above with respect to FIGS. 1 and 2.

The method 500 can include, at step 504, pulling the resin-injected feedstock through a pultrusion die. The pultrusion die can shape the resin-injected feedstock into a three-dimensional profile shape having one or more profile surfaces. In an example, the step of pulling the feedstock 504 can be performed by the pulling mechanism 166, 266 described above with respect to FIGS. 1 and 2. The pultrusion die used in the step of pulling the feedstock 504 can be the pultrusion die 112, 212 described above with respect to FIGS. 1 and 2.

Continuing with FIG. 6, the method 500 includes, at 506, applying a coating onto the pultrusion substrate. Applying the coating 506 can include: at 508, optionally adhering one or more adhesive materials onto at least a portion of the one or more profile surfaces of the pultrusion substrate to form one or more adhesive tie layers on the pultrusion substrate; and, at 510, applying a protective bilayer comprising an inner protective layer (e.g., the inner layer 306, 406) and an outer protective layer (e.g., the outer layer 308, 408) to the pultrusion substrate (e.g., either directly to one or more profile surfaces of the pultrusion substrate or to the one or more adhesive tie layers formed in step 508) to provide the coated pultrusion article. Whether the method 500 includes just applying the protective bilayer such that applying the coating 506 only includes step 510 or comprises both forming the one or more adhesive tie layers and applying the protective bilayer such that applying the coating 506 includes both steps 508 and 510, will depend on the material of the pultrusion substrate, and in particular the material of the polymer resin. As described above, when a polyester-based resin is used, the protective bilayer materials described above are able to be applied and bonded directly to the pultrusion substrate, such that step 508 can be omitted. However, when a polyurethane-based resin is used, it is often difficult to bond the protective bilayer directly to the urethane-based substrate, such that step 508 can be included to provide an adhesive bilayer that can adhere the protective bilayer to the pultrusion substrate.

In examples that include the step of forming the one or more adhesive tie layers 508, the step 508 can include heating the pultrusion substrate to an adhesive-application temperature. The adhesive-application temperature can be a temperature that will enable one or more of: improved adhesion of the adhesive material to the pultrusion substrate or improved formation of the one or more adhesive tie layers. In an example, the pultrusion substrate is heated to an adhesive-application temperature is at least about 110° F. In an example, heating the pultrusion substrate to promote adhesion of the adhesive tie layers (e.g., as part of step 508) can include raising the temperature of the pultrusion substrate to at least about 250° F. so that the pultrusion substrate can cool slightly before the adhesive material is applied to the pultrusion substrate, and such that the adhesive material can still sufficiently adhere. Forming the one or more adhesive tie layers 508 can further include extruding the one or more adhesive materials onto at least the one or more profile surfaces of the pultrusion substrate, such as through an adhesive extrusion die, for example a cross-head extrusion die, i.e., so that the adhesive layers 508 (if used) are extruded in-line directly onto the profile surfaces of the pultrusion substrate. In an example, the adhesive-application assembly 254 described above with respect to FIG. 2 can be used to apply and adhere the one or more adhesive materials, for example with the adhesive material extruder 256.

Applying the protective bilayer 510 can include extruding a coating material of the inner protective layer and the outer protective layer onto the pultrusion substrate. In examples where the method 500 includes forming the one or more adhesive tie layers (step 508), then the step of applying the protective bilayer 510 includes applying the protective bilayer onto the one or more adhesive tie layers. In examples where step 508 is omitted, the step of applying the protective bilayer 510 includes applying the protective bilayer directly onto one or more profile surfaces of the pultrusion substrate, e.g., cross-head extruding the one or more protective layers 510 directly onto the one or more profile surfaces of the pultrusion substrate or onto the one or more adhesive layers already cross-head extruded onto the pultrusion substrate. In an example, the step of applying the protective bilayer 510 can include extruding each of the coating materials of the inner and outer protective layers through an extrusion die, such as a cross-head extrusion die that can cross-head extrude the coating material or materials onto the profile surfaces of the pultrusion substrate or onto the one or more adhesive tie layers.

In some examples, the inner protective layer and the outer protective layer can each be applied by its own coating extrusion die. For example, in the system 100 shown in FIG. 1, a first protective coating material (e.g., a thermoplastic material comprising a first acrylic or acrylic-based polymer) can be extruded through a first coating material extruder 142 to form the inner protective layer and a second protective coating material (e.g., a second thermoplastic material comprising a polymer blend of a first thermoplastic polymer and a second thermoplastic polymer, wherein the first thermoplastic polymer comprises a fluoropolymer and the second thermoplastic polymer comprises a second acrylic or acrylic-based polymer) can be extruded through a second coating material extruder 148 to form the outer protective layer. In other examples, the inner protective layer (e.g., the inner layer 306, 406) and the outer protective layer (e.g., the outer layer 308, 408) can be formed by coextrusion. For example, the system 200 shown in FIG. 2 includes a coextrusion die 260 that coextrudes a first protective coating material to form the inner protective layer (such as one comprising the first acrylic or acrylic-based polymer) and a second coating material to form the outer protective layer (such as one formed from a polymer blend of a fluoropolymer and a second acrylic or acrylic-based polymer). In an example, the protective coating materials of the inner and outer protective layers are selected to have as closely matching viscosity as possible to optimize adhesion between the coextruded and adjacent protective layers that form the protective bilayer.

In some examples where applying the coating 506 includes both forming the one or more adhesive tie layers 508 and applying the protective bilayer 510, the step of applying the coating 506 can comprise coextruding the one or more adhesive materials and the protective coating materials in substantially the same step. For example, as shown in the system 200 of FIG. 2, the coextrusion die 260 not only coextrudes the first and second protective coating materials, but also coextrudes the adhesive material to form the one or more adhesive tie layers. In an example, the one or more adhesive materials and the protective coating materials are selected to have as closely matching viscosity as possible to optimize adhesion between the coextruded and adjacent adhesive tie layer and coating layer.

In an example, two or more of resin-injecting the feedstock 502, pulling the feedstock 504, forming the one or more adhesive tie layers 508 (if performed), and applying the protective bilayer 510 can be conducted in a common in-line continuous process. In an example, all of the steps of resin-injecting the feedstock 502, pulling the feedstock 504, forming the one or more adhesive ties layers 508, and applying the protective bilayer 510 are conducted in a common in-line continuous process.

In an example, the method 500 can optionally include, at 512, cooling the coated pultrusion article. Cooling the coated pultrusion article 512 can include one or more of: passively exposing the coated pultrusion article to cooling air, such as air at ambient conditions or further chilled air; applying forced air to the coated pultrusion article, for example at ambient temperature or a cooled or chilled temperature; applying a liquid cooling medium to one or more surfaces of the coated pultrusion article, such as by immersing the coated pultrusion article in a cooling immersion bath or by spraying a liquid cooling medium onto one or more surfaces of the coated pultrusion article coated profile.

The method 500 can further include, at 514, cutting the coated pultrusion article to a specified size. Cutting the coated pultrusion article 514 can be performed with any device capable of accurately cutting the elongate coated pultrusion article to a specified size, such as a specified length. Cutting the coated pultrusion article 514 can also include cutting the coated pultrusion article with a specified cutting shape, e.g., a straight cut, a beveled cut, a chamfered cut, a fillet cut, and the like.

### EXAMPLES

Various embodiments of the present invention can be better understood by reference to the following Examples which are offered by way of illustration. The present invention is not limited to the Examples given herein.

### Coated Articles

Each of the coating materials described in EXAMPLES 1-3 are an extrudable polymer blend of a PVDF-based polymer and an acrylic polymer. Each of the coating materials described in COMPARATIVE EXAMPLES 4-6 are either another extrudable polymer blend of a PVDF-based polymer and an acrylic polymer or are a PVDF-based polymer that is not blended with an acrylic or acrylic-based polymer, which is included for the purposes of comparison with one or more of the coating materials described in EXAMPLES 1-3.

Each extrudable coating material of EXAMPLES 1-3 and COMPARATIVE EXAMPLES 4-6 can be used to form one or more layers of a protective coating for use on a fenestration article. In particular, each extrudable coating material of EXAMPLES 1-3 and COMPARATIVE EXAMPLES 4-6 is used to form the outer layer of a bilayer coating structure, such as the outer layer 408 in the protective bilayer coating 404 described above with respect to FIG. 5. Therefore, in each EXAMPLE or COMPARATIVE EXAMPLE, the coating material described is coextruded with a poly(methyl methacrylate) (“PMMA”) that is sold by Arkema S. A., Colombes France (also referred to as “Arkema”), through its Altuglas International division (hereinafter “Altuglas”), with catalog or item number A212M (also referred to hereinafter as “A212 PMMA” or simply as “A212”), to form the inner layer of the bilayer coating, e.g., the inner layer 406 of the bilayer coating 404 in FIG. 5. For each EXAMPLE or COMPARATIVE EXAMPLE, a thermoplastic polyurethane extrudable adhesive was coextruded along with the specified coating material and the A212. The extrudable adhesive material forms an adhesive tie layer between a pultruded substrate and the A212 inner layer, e.g., the adhesive tie layer 418 to bond the inner layer 406 to the pultrusion substrate 402. The resulting coated article, e.g., article 400, for each EXAMPLE and COMPARATIVE EXAMPLE are tested as described below.

### Example 1

A first coating material was formed by blending the PVDF-based copolymer sold under the trade name KYNAR FLEX 2850 by Arkema (referred to hereinafter as the “Kynar 2850 fluoropolymer,” the “Kynar 2850 copolymer,” or simply “Kynar 2850”) with an acrylic polymer. The exact chemical composition of the Kynar 2850 fluoropolymer is proprietary, however, the present inventors believe that the Kynar 2850 fluoropolymer comprises primarily polymerized first monomer units derived from vinylidene difluoride (also referred to as “VDF monomer units,” “VDF units,” or simply “VDF”) copolymerized with second monomer units derived from hexafluoropropylene (also referred to as “HFP monomer units,” “HFP units,” or simply “HFP”) with the general chemical formula [A] provided above, wherein the molar percentage of the VDF monomer units in the Kynar 2850 fluoropolymer is believed to be from about 92.5 mol. % to about 97.5 mol. %, e.g., wherein the molar percentage of the HFP monomer units are from about 2.5 mol % to about 7.5 mol. %.

The Kynar 2850 is melted to form a molten resin, which is blended with clear beads of PMMA sold by Arkema S. A., Colombes France (also referred to as “Arkema”), through its Altuglas International division (hereinafter “Altuglas”), with catalog or item number A212M (also referred to hereinafter as “A212 PMMA” or simply as “A212”, also referred to herein as “A212 beads”, which is 10% crosslinked. The A212 beads are added in a proportion so that the final blend of the Kynar 2850 and the A212 is 10 wt. % of the A212 PMMA and 90 wt. % of the Kynar 2850. When extruded, this composition forms the coating material of EXAMPLE 1. Two separate samples of the coating material of EXAMPLE 1 were made for testing, identified as EXAMPLE 1-Sample A (or “Sample 1(A)”) and EXAMPLE 1-Sample B (or “Sample 1(B)”).

### Example 2

A second coating material was formed by blending the PVDF-based homopolymer sold under the trade name KYNAR 705 by Arkema (referred to hereinafter as the “Kynar 705 fluoropolymer,” “the Kynar 705 polymer” or simply “Kynar 705”) with an acrylic polymer. The composition of the Kynar 705 resin is proprietary, however, the present inventors believe that the primary component (e.g., at least 98%) is a PVDF homopolymer, e.g., a polymer where 100% of the monomer units are derived from VDF with no copolymerized comonomer units, i.e., the fluoropolymer has no HFP comonomer units, in contrast to the PVDF-based Kynar 2850 copolymer used to form the first coating material in EXAMPLE 1.

Similar to the polymer blend formed in EXAMPLE 1, the Kynar 705 is melted to form a molten resin, which is blended with the same A212 beads as in EXAMPLE 1 such that the final blend of the Kynar 705 and the A212 is 10 wt. % of the A212 PMMA and 90 wt. % of the Kynar 705. When extruded, this composition forms the second coating material of EXAMPLE 2. Two separate samples of the coating material of EXAMPLE 2 were made for testing, identified as EXAMPLE 2-Sample A (or “Sample 2(A)”) and EXAMPLE 2-Sample B (or “Sample 2(B)”).

### Example 3

A third coating material that is similar to the second coating material of EXAMPLE 2 was formed by blending the same Kynar 705 PVDF-based homopolymer with an acrylic polymer. But, instead of blending the Kynar 705 with the PMMA sold by item number A212, in EXAMPLE 3 the Kynar 705 is blended with the PMMA that is sold by Altuglas with catalog or item number A210 (also referred to hereinafter as “A210 PMMA” or simply as “A210”). Similar to the polymer blends formed in EXAMPLES 1 and 2, in EXAMPLE 3 the Kynar 705 is melted to form a molten resin, which is blended with the A210 such that the final blend of the Kynar 705 and the A210 is 10 wt. % of the A210 PMMA and 90 wt. % of the Kynar 705. When extruded, this composition forms the second coating material of EXAMPLE 3.

### Comparative Example 4

For the purpose of a control comparison, a fourth coating material was used that is entirely or substantially entirely formed from the Kynar 705 PVDF homopolymer (e.g., that is 100 wt. % of the Kynar 705 or that is approximately 100 wt. % Kynar 705 with only small amounts of other additives and with 0 wt. % of an acrylic or acrylic-based polymer blended with the Kynar 705). In other words, the fifth coating material of COMPARATIVE EXAMPLE 5 consists of the Kynar 705 or consists essentially of the Kynar 705.

### Comparative Example 5

For the purpose of a control comparison, a fifth coating material was used that is entirely or substantially entirely formed from the Kynar 2850 PVDF copolymer (e.g., that is 100 wt. % of the Kynar 2850 or that is approximately 100 wt. % Kynar 2850 with only small amounts of other additives and with 0 wt. % of an acrylic or acrylic-based polymer blended with the Kynar 2850). In other words, the fourth coating material of COMPARATIVE EXAMPLE 4 consists of the Kynar 2850 or consists essentially of the Kynar 2850.

### Comparative Example 6

For the purpose of comparison, a sixth coating material was used that is similar to the polymer blends of Examples 1-3, but that comprises different relative amounts of the PVDF-based fluoropolymer and the acrylic or acrylic-based polymer. The sixth coating material was formed by blending the Kynar 705 PVDF-based polymer with the A210 PMMA, but instead of the 10 wt. % PMMA as in the blends of EXAMPLES 1-3, the blend of COMPARATIVE EXAMPLE 6 is 40 wt. % of the A210 PMMA and 60 wt. % of the Kynar 705.

### Performance Testing

Surface Free Energy

Surface free energy (also referred to as “SFE”) is one means of measuring the wettability of coated articles by liquids. Often, the SFE of a solid surface is subdivided into a polar fraction and a non-polar fraction (usually referred to as the “disperse fraction” when referring to the SFE). For the coated articles for which SFE was tested, the polar fraction SFE was measured by contacting the outer surface with water and measuring the resulting surface free energy, while the disperse fraction SFE was measured by contacting the outer surface with diiodomethane (CH₂I₂) and then measuring the resulting surface free energy.

A low value for the polar SFE fraction of a solid surface results in low wettability of the solid by polar liquids such as water and aqueous solutions, while a low value for the disperse SFE fraction will result in low wettability of the solid by non-polar liquids such as liquid alkanes.

A high value for each SFE fraction will also tend to repel a liquid of the other type of liquid. For example, a high value for the disperse SFE fraction will mean that the solid surface will tend to repel polar liquids such as water, at least if the surface does not also have a correspondingly high polar SFE fraction. Similarly, a high polar SFE fraction will tend to repel non-polar liquids, at least if the surface does not have a correspondingly high disperse SFE fraction.

In the case of the protective coating materials of the present disclosure, the SFE and its separate fraction can give an idea of how susceptible the coating materials and the underlying layers that are protected thereby will be to corrosive materials such as cleaning chemicals or detergents. The majority of cleaning chemicals that may be applied to articles coated with the materials described in the present application are solutions of compounds that are soluble or dispersible in water such that most cleaning compounds are polar. Therefore, the lower the overall SFE and, more importantly, the polar SFE fraction will be instructive for the purpose of evaluating potential corrosion resistance.

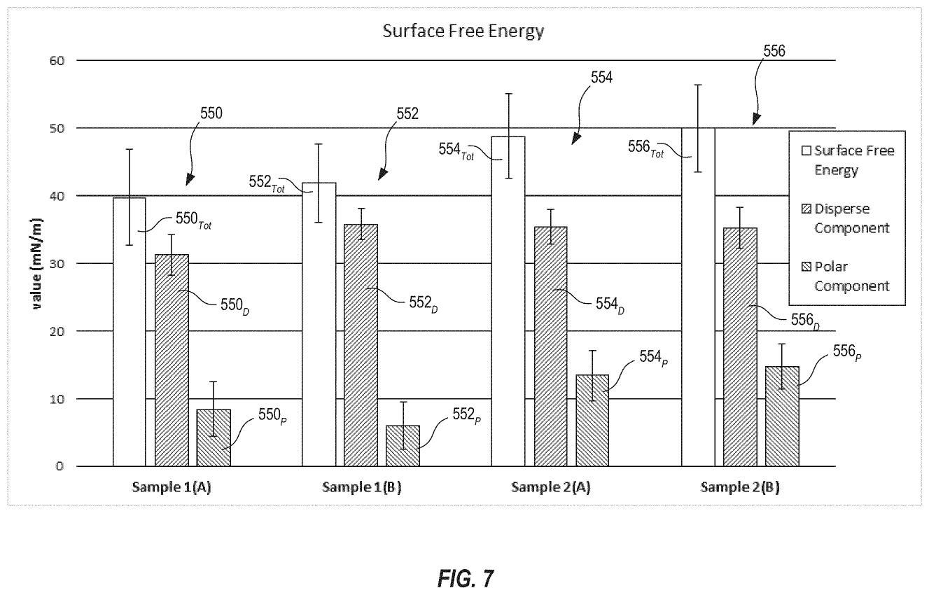

FIG. 7 is a bar graph of the overall SFE, the disperse fraction, and the polar fraction for the outer surface of the coating materials of EXAMPLE 1, Sample 1(A) (data bars 550), EXAMPLE 1, Sample 1(B) (data bar 552), EXAMPLE 2, Sample 2(A) (data bars 554), and EXAMPLE 2, Sample 2(B) (data bars 556). As can be seen in FIG. 7, the first coating material of EXAMPLE 1 has an overall SFE (data bars 550_{Tot} and 552_{Tot} for Samples 1(A) and 1(B), respectively) that is about 15% to 20% lower than (i.e., from about 80% to about 85% of) the overall SFE of the second coating material of Example 2 (data bars 554_{Tot} and 556_{Tot} for Samples 2(A) and 2(B), respectively). In addition, the first coating material of EXAMPLE 1 demonstrated a polar SFE fraction (data bars 550_{P} and 552_{P} for Samples 1(A) and 1(B), respectively) that is from about 40% to 60% lower than (i.e., from about 40% to about 60% of) the polar SFE fraction of the second coating material of EXAMPLE 2 (data bars 554_{P} and 556_{P} for Samples 2(A) and 2(B), respectively).

The SFE data indicates that there is a difference in reaction to polar components between the coating materials of EXAMPLES 1 and 2. It is believed that the polar fraction of SFE gives an indication of wetting and adherability of polar compounds to the outer surface of the coating materials. It is also believed that the polar fraction SFE measurements may be indicative of the compatibility of the coating materials with glazing or sealing of the coating material with glazing or sealant materials applied over the top of the coating material.

Adhesion Testing

Multiple test methods were used to test adhesion performance of several of the coating materials described in EXAMPLES 1-3 and COMPARATIVE EXAMPLES 4-6

Pull-Off Adhesion

Samples were tested for pull-off adhesion by applying a specified amount of force on a specified area of the coating material, typically measured in pounds-force per square inch or “psi,” until the coating portion to which the force is applied or one or more underlying substrates or layers to which the coating material is adhered fails such that the coating material is “pulled off” of its underlying substrate or layer. The force applied during the pull-off adhesion test is applied in a direction that is normal or substantially normal to the plane of the outer surface of the coating material. The pull-off adhesion was tested using a pull-off adhesion testing device sold by Defelsko Corp. (Ogdensburg, N.Y., USA) under the trade name POSITEST AT, such that the pull-off adhesion test is also sometimes referred to as a “positester test” and the pull-off adhesion testing device is sometimes referred to as a “positester.” The pull-off adhesion test was conducted generally according to one or more standardized test procedures including, but not limited to, the standards published by ASTM International (formerly the American Society for Testing and Materials or “ASTM”) as ASTM D4541 and ASTM D7522, the standard published by the International Organization for Standardization (“ISO”) as ISO 4624, the standard published by the European Standards body (“EN”) as EN 1542, and the standard jointly published by the Standards Australia body (“AS”) and Standards New Zealand boy (“NZS”) as AS/NZS 1580.408.5.

The coating formed using the first coating material of EXAMPLE 1 had a pull-off adhesion value of after four different pull-off adhesion tests of 1,204 psi, 1,124 psi, 1,202 psi, and 408 psi. The 408 psi test result was believed to be an anomaly value and that the other three values are a better indication of the pull-off adhesion strength of the first coating material of EXAMPLE 1. Any value over 1,000 psi is considered “acceptable” for the purposes of the scratch-resistant coating such as the coating material of EXAMPLE 1.

Boil Adhesion

Each of the samples of EXAMPLES 1-3 and COMPARATIVE EXAMPLES 4-6 were subjected to the boil adhesion test as defined in the AAMA 625 Voluntary Specification. All samples were able to satisfactorily pass the AAMA 625 standard boil test.

Scrape Adhesion

Samples 1(A) and 1(B) of EXAMPLE 1 and Samples 2(A) and 2(B) of EXAMPLE 2 were tested for scrape adhesion strength using a testing device sold by BYK-Gardner GmbH (Wesel, Germany, hereinafter “BYK-Gardner”) as a “Balanced Beam Scrape and Mar Tester.” The scrape adhesion test was conducted substantially in compliance with standardized test procedures for scrape adhesion tests such as those described in the standards published by ASTM as ASTM D2197 and ASTM D5178.

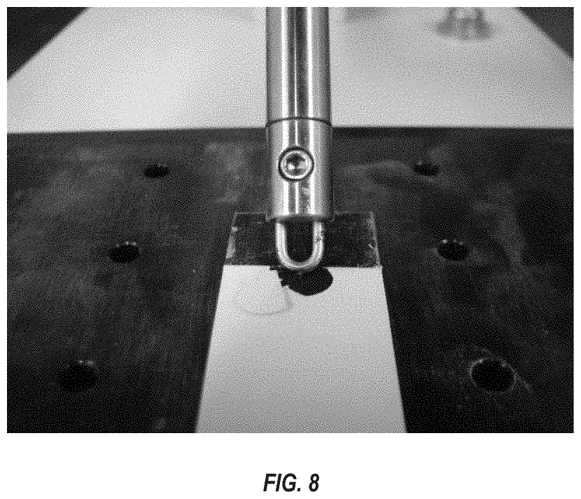

FIG. 8 shows the scrape arm portion of the scrape adhesion testing device. The scrape adhesion testing device also includes a horizontal balance beam (not shown in FIG. 8) upon which is placed a specified weight. The balance beam is configured so that the weight is positioned directly above the distal end of the scrape arm so that substantially constant force is applied by the scrape arm in a direction that is coaxially aligned with a central axis of the scrape arm. As can be seen in FIG. 8, the scrape arm central axis is oriented at an angle of about 45° relative to the outer surface of the coating being scraped by the scrape adhesion testing device.

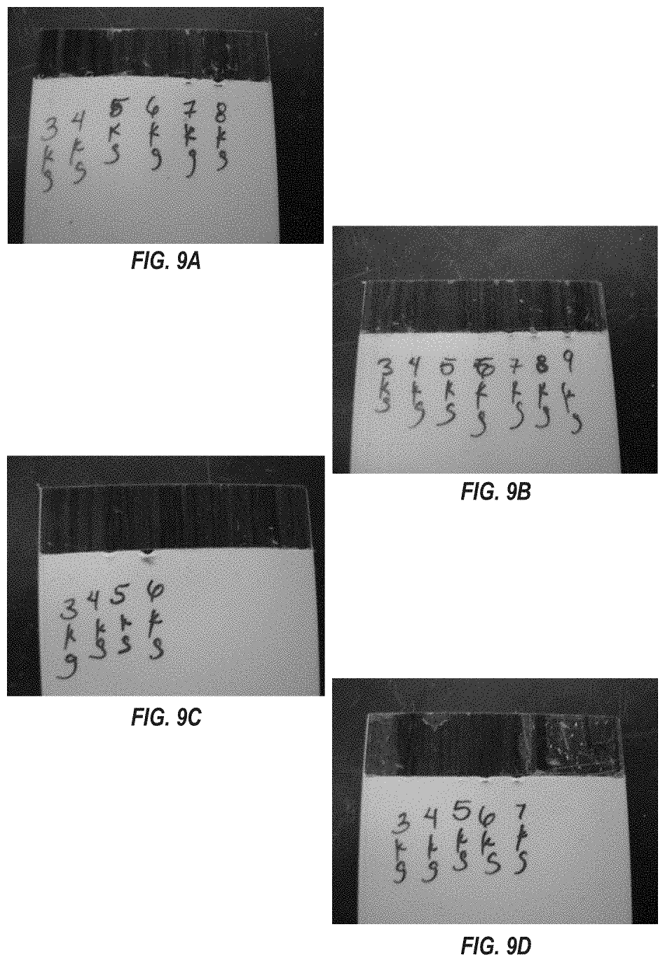

For each sample coating material, a set amount of weight was added to the scrape adhesion testing device was set, starting with a weight of three (3) kilograms (kg) and increasing by increments of one (1) kg until a particular coating sample failed (e.g., with a specified amount of the coating being scraped off by the scrape adhesion testing device). The resulting samples of the scrape adhesion test are shown in FIGS. 9A-9D. The coating material of EXAMPLE 1, Sample 1(A) is shown in FIG. 9A, the coating material of EXAMPLE 1, Sample 1(B) is shown in FIG. 9B, the coating material of EXAMPLE 2, Sample 2(A) is shown in FIG. 9C, and the coating material of EXAMPLE 2, Sample 2(B) is shown in FIG. 9D. As can be seen in FIGS. 9A and 9B, the coating material of EXAMPLE 1 (i.e., with the outer coating layer formed from a blend of 90 wt. % Kynar 2850 and 10 wt. % A212) produced slightly better scrape adhesion performance compared to that of EXAMPLE 2 (shown in FIGS. 9C and 9D, i.e., with the outer coating layer formed from a blend of 90 wt. % Kynar 705 and 10 wt. % A212). For example, Sample 1(A) did not fail until eight (8) kg was added to the scrape adhesion testing device, while Sample 1(B) did not fail until nine (9) kg was added. In contrast, Samples 2(A) and 2(B) failed at six (6) kg and seven (7) kg, respectively.

Scratch Resistance

Samples 1(A) from EXAMPLE 1, Samples 2(A) and 2(B) from EXAMPLE 2, and the coating material of EXAMPLE 3 were tested for scratch resistance using a scratch resistance testing device sold by Paul N. Gardner Co. (Pompano Beach, Fla., USA, which is a division of BYK-Gardner) as the “Multi-Finger Scratch/Mar Tester 710.” The scrape adhesion test was conducted substantially similarly to scratch and mar resistance testing that is typically performed in the automotive industry, such as: test procedures LP-463DD-18-01 and PF-10938 for Chrysler (division of Stellantis North America, Auburn Hills, Mich., USA); test procedure BO 162-01 for Ford Motor Co. (Dearborn, Mich., USA); test procedure GMW 14698 for General Motors Corp. (Detroit, Mich., USA); and test procedure NEW M0159 for Nissan Motor Corp. (Yokohama, Japan).

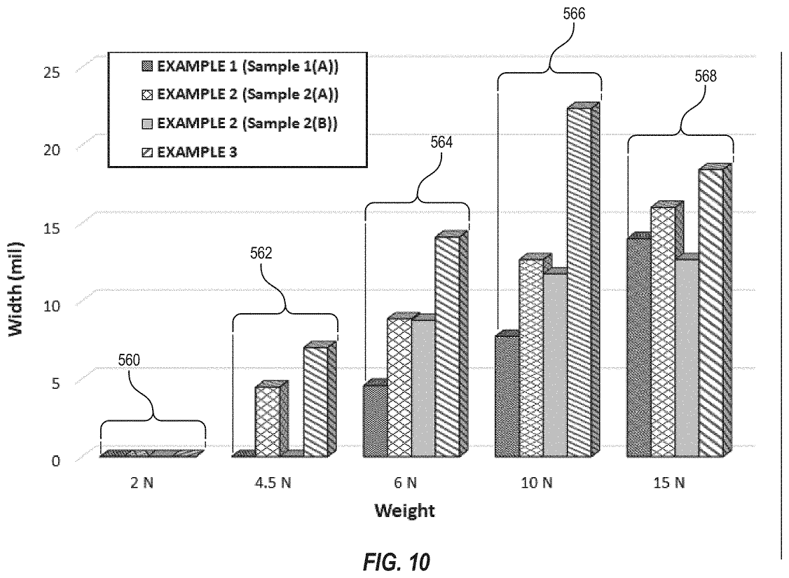

The scratch resistance testing device included five different testing arms, also referred to as “fingers,” that were each forced down with a different specified weight while passing across the outer surface of the coating. For this reason, the scratch resistance testing device will also be referred to herein as “the five-finger scratch tester.” The results of the five-finger scratch test are shown in FIG. 10. For each finger of the five-finger scratch tester, the width (in mils) of any resulting scratch was measured, with a wider scratch corresponding to the coating being less resistant to scratching by the finger having that specified weight applied.

For the five-finger scratch tester data of FIG. 10, the specified weights placed on the fingers were—(1) a 2 Newton (“N”) weight on a first finger (also referred to herein as the “2 N finger,” data series 560 in FIG. 10); (2) a 4.5 N weight on a second finger (the “4.5 N finger,” data series 562); (3) a 6 N weight on a third finger (the “6 N finger,” data series 564); (4) a 10 N weight on a fourth finger (the “10 N finger,” data series 566); and (5) a 15 N weight on a fifth finger (the “15 N finger,” data series 568). The device is configured to drag all of the fingers across the outer surface of the coating being tested so that the tip of each finger is scraped across the outer surface in order to test the coating's scratch resistance to the force being applied by each specified weight.

As can be seen, the coating material of EXAMPLE 1 (Sample 1(A)) performed significantly better (e.g., resulted in narrower scratches) than the coatings of EXAMPLE 2 and 3 for all of the applied weights except for the 15 N finger. For the 15 N finger, the difference between the width for the coating material of EXAMPLE 1 does not appear to have been significantly different from that of the coating materials of EXAMPLES 2 and 3.

Impact Resistance

Samples 1(A) from EXAMPLE 1, Samples 2(A) and 2(B) from EXAMPLE 2, and the coating material of EXAMPLE 3 were tested for impact resistance using an impact testing device sold by Intertek Group plc (London, England, UK) as the “Falling Dart Impact” tester (also referred to as a “Gardner Impact” tester). The impact resistance test was conducted according to the ASTM standard published as ASTM D5420. The test involved dropping an impactor with a four (4) pound weight from a specified height of 20 inches (equating to 80 in-lbf). After impact, a tape with a pressure sensitive adhesive was applied to the impact site and then removed to see how much any of the coating material comes off with the tape.

All four samples generally had the same generally acceptable performance, with Sample 1(A) exhibiting the least amount of damage.

Chemical Resistance

Samples 1(A) from EXAMPLE 1, Samples 2(A) and 2(B) from EXAMPLE 2, and the coating material of EXAMPLE 3 were tested for chemical resistance by exposing each sample to a 50 vol. % solution of isopropyl alcohol (“IPA”) for twenty four (24) hours and with each sample being bent with a specified induced strain of about 0.3% bending.

After the 24 hours of exposure, the samples were removed from the 50% IPA solution and were inspected. All four samples showed excellent chemical resistance, with no cracks, discoloration, or visible defects being observed in any of the samples after exposure to the relatively highly corrosive IPA at a high concentration.

Thermal Stability

Samples 1(A) from EXAMPLE 1, Samples 2(A) and 2(B) from EXAMPLE 2, and the coating material of EXAMPLE 3 were tested for thermal stability by exposing each sample to 10 thermal-exposure cycles, with each cycle comprising ramping up from approximately room temperature conditions to 85° C. (about 185° F.) and 85% relative humidity and holding at this temperature and humidity for 600 minutes (10 hours), then cooling down to −40° C. (about −40° F.) and holding at that temperature for 30 minutes (0.5 hours), before finally ramping up to 23° C. (about 73° F.) and 50% relative humidity for the end of the cycle. The thermal stability test was performed generally consistently with the standard published by the International Electrotechnical Commission (“IEC”) as IEC 591/08.

After the 10 thermal-exposure cycles, the samples were examined for any delamination, cracking, or any other visual effects of their corresponding coating materials. The adhesion of the coatings were also tested using the positestor pull-off adhesion test described above. The samples were also tested for chemical resistance to 50% IPA as described above. All four samples showed excellent response to the thermal cycling test, with no noticeable physical damage to the coating materials and no appreciable change in the pull-off adhesion or the chemical resistance of the coating materials.

Capillary Rheometry

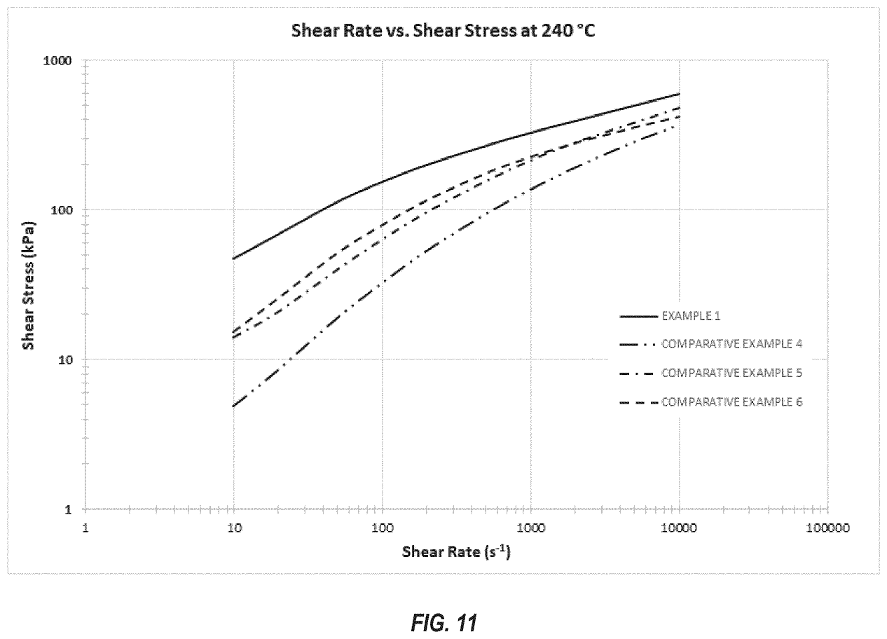

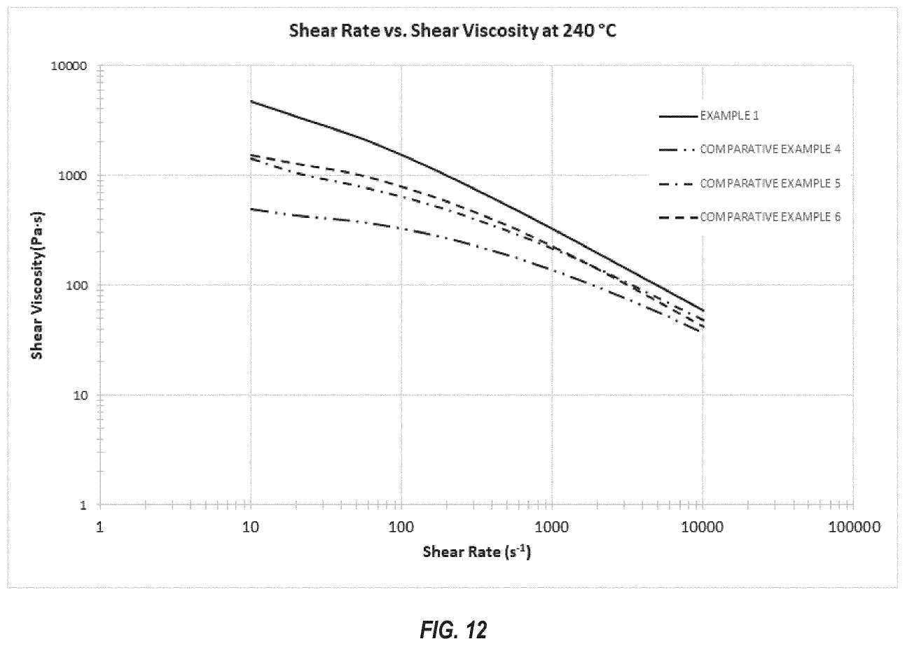

Sample 1(A) from EXAMPLE 1 and the coating materials of COMPARATIVE EXAMPLES 4-6 were tested for processability (e.g., extrudability) using a capillary rheometer sold under the trade name RHEOGRAPH 20 by Göttfert Werkstoff-Prüfmaschinen GmbH (Buchen, Germany). The capillary rheometry testing was performed generally consistently with the ASTM standard published by ASTM D3835. Both shear stress (measured in kilopascals (KPa)) and shear viscosity (measured in pascal-seconds (Pa·S)) for the materials were measured across a broad range of shear rates (measured in inverse seconds, s⁻¹) at an extrusion temperature of 240° C. (about 465° F.). The shear stress data is shown in FIG. 11 and the shear viscosity data is down in FIG. 12.

As can be seen FIGS. 11 and 12, across the entire range of shear rates tested, the coating material of EXAMPLE 1 (Sample 1(A)) (i.e., the blend of 90 wt. % Kynar 2850 PVDF copolymer and 10 wt. % A212 PMMA) has a significantly higher shear stress and shear viscosity than the coating material of COMPARATIVE EXAMPLE 6 (i.e., the blend of 60 wt. % Kynar 705 PVDF and 40 wt. % A212 PMMA). As can also be seen in FIGS. 11 and 12, the coating material of COMPARATIVE EXAMPLE 6 has a comparable shear stress and shear viscosity profile to that of COMPARATIVE EXAMPLE 4 (i.e., 100 wt. % Kynar 2850 PVDF copolymer), which are both significantly higher than the shear stress and shear viscosity for the coating material of COMPARATIVE EXAMPLE 5 (i.e., 100 wt. % Kynar 705 PVDF homopolymer). The higher shear stress and higher shear viscosity correspond to the coating material being easier to process, e.g., easier to extrude at typical processing conditions for cross-head extrusion onto a pultrusion substrate by providing for a wider processability window at a nominal processing temperature and a lower pressure. The viscosity of the EXAMPLE 1 coating material is a better match for the viscosity of the inner layer material (e.g., the PMMA layer) during coextrusion compared to those of COMPARATIVE EXAMPLES 4, 5, and 6.

The above detailed description includes references to the accompanying drawings, which form a part of the detailed description. The drawings show, by way of illustration, specific embodiments in which the invention can be practiced. These embodiments are also referred to herein as “examples.” Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

In the event of inconsistent usages between this document and any documents so incorporated by reference, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

Method examples described herein can be machine or computer-implemented at least in part. Some examples can include a computer-readable medium or machine-readable medium encoded with instructions operable to configure an electronic device to perform methods as described in the above examples. An implementation of such methods can include code, such as microcode, assembly language code, a higher-level language code, or the like. Such code can include computer readable instructions for performing various methods. The code may form portions of computer program products. Further, in an example, the code can be tangibly stored on one or more volatile, non-transitory, or non-volatile tangible computer-readable media, such as during execution or at other times. Examples of these tangible computer-readable media can include, but are not limited to, hard disks, removable magnetic disks, removable optical disks (e.g., compact disks and digital video disks), magnetic cassettes, memory cards or sticks, random access memories (RAMs), read only memories (ROMs), and the like.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to comply with 37 C.F.R. § 1.72(b), to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description as examples or embodiments, with each claim standing on its own as a separate embodiment, and it is contemplated that such embodiments can be combined with each other in various combinations or permutations. The scope of the invention should be determined with reference to the appended claims, along with the full scope of equivalents to which such claims are entitled.

What is claimed is:

1. A coated article comprising:
a composite substrate formed from a reinforcing feedstock at least partially embedded in a matrix polymer, the composite substrate comprising an outer surface; and
a coating comprising a protective bilayer comprising:
a first thermoplastic protective layer comprising an inner face coupled to the outer surface of the composite substrate, wherein the first protective layer is formed from a first acrylic or acrylic-based polymer; and
a second thermoplastic protective layer coupled to the first thermoplastic protective layer at an interface, wherein the interface opposes the inner face of the first protective layer, the second protective layer comprising an outer face that opposes the interface,
wherein the second thermoplastic protective layer is formed from a polymer blend of a first thermoplastic polymer and a second thermoplastic polymer, wherein the first thermoplastic polymer comprises a first fluoropolymer comprising polymerized first monomer units derived from a hydrofluoro-olefin, or a second fluoropolymer comprising polymerized second monomer units derived from a perfluorinated alkene, or a combination thereof, wherein the second thermoplastic polymer comprises a second acrylic or acrylic-based polymer, and wherein the first thermoplastic polymer is at least about 75 wt. % of the polymer blend.

2. A coated article according to claim 1, wherein the first monomer units are derived from vinylidene difluoride or from a substituted vinylidene fluoride.

3. A coated article according to claim 2, wherein the first thermoplastic polymer consists of one or more first fluoropolymers each comprising at least about 90 mol. % of the polymerized first monomer units derived from vinylidene difluoride or from a substituted vinylidene fluoride.

4. A coated article according to claim 1, wherein the first fluoropolymer includes a homopolymer consisting of the polymerized first monomer units or a copolymer comprising at least about 90 mol. % of the polymerized first monomer units, or a combination thereof.

5. A coated article according to claim 4, wherein the copolymer comprises an effective amount of up to about 6 mol. % of copolymerized third monomer units derived from hexafluoropropylene.

6. A coated article according to claim 1, wherein the second monomer units are derived from tetrafluoroethylene or a substituted tetrafluoroethylene.

7. A coated article according to claim 1, wherein at least 90 wt. % of the first thermoplastic polymer comprises the first fluoropolymer.

8. A coated article according to claim 1, wherein the first thermoplastic polymer is at least about 85 wt. % of the second thermoplastic material.

9. A coated article according to claim 1, wherein one or both of the first acrylic or acrylic-based polymer and the second acrylic or acrylic-based polymer comprises: poly(methyl methacrylate), poly(methyl acrylate), a polyacetyl, or a combination thereof.

10. A method of manufacturing a coated article, the method comprising:
forming a composite substrate comprising a reinforcing feedstock at least partially embedded in a matrix polymer, the composite substrate comprising an outer surface;
applying a first thermoplastic material comprising a first acrylic or acrylic-based polymer onto at least a portion of the outer surface of the composite substrate to form a first protective layer comprising an inner face coupled to the outer surface of the composite substrate and an outer interface; and
applying a second thermoplastic material onto at least a portion of the outer interface of the first protective layer to form a second protective layer coupled to the first protective layer at the outer interface such that the second protective layer has an outer face that opposes the outer interface,
wherein the second thermoplastic material comprises a polymer blend of a first thermoplastic polymer and a second thermoplastic polymer, wherein the first thermoplastic polymer comprises a first fluoropolymer comprising polymerized first monomer units derived from a hydrofluoro-olefin or a second fluoropolymer comprising polymerized second monomer units derived from a perfluorinated alkene, or a combination thereof, wherein the second thermoplastic polymer comprises a second acrylic or acrylic-based polymer, and wherein the first thermoplastic polymer is at least about 85 wt. % of the second thermoplastic material.

11. A method according to claim 10, wherein the first monomer units are derived from vinylidene difluoride or from substituted vinylidene difluoride.

12. A method according to claim 11, wherein the first thermoplastic polymer consists of one or more first fluoropolymers each comprising at least about 90 mol. % of the polymerized first monomer units derived from vinylidene difluoride or from substituted vinylidene difluoride.

13. A method according to claim 10, wherein the first fluoropolymer includes a homopolymer consisting of the polymerized first monomer units or a copolymer comprising at least about 90 mol. % of the polymerized first monomer units, or a combination thereof.

14. A method according to claim 13, wherein the copolymer comprising an effective amount of up to about 6 mol % of copolymerized third monomer units derived from hexafluoropropylene.

15. A method according to claim 10, wherein the second monomer units are derived from tetrafluoroethylene or a substituted tetrafluoroethylene.

16. A method according to claim 10, wherein one or both of the first acrylic or acrylic-based polymer and the second acrylic or acrylic-based polymer comprises: poly(methyl methacrylate), poly(methyl acrylate), a polyacetyl, or a combination thereof.

17. A method according to claim 10, wherein the first thermoplastic polymer is at least about 90 wt. % of the second thermoplastic material.

18. A method according to claim 10, wherein applying the first thermoplastic material comprises extruding the first thermoplastic material through an extrusion die onto at least the portion of the outer surface of the composite substrate.

19. A method according to claim 10, wherein applying the second thermoplastic material comprises extruding the polymer blend through an extrusion die onto at least the portion of the outer interface of the first protective layer.

20. A method according to claim 10, wherein applying the first and second thermoplastic materials comprises coextruding the first and second thermoplastic materials through a coextrusion die that simultaneously or substantially simultaneously:
applies the first thermoplastic material onto at least the portion of the outer surface of the composite substrate to form the first protective layer, and
applies the second thermoplastic material onto at least the portion of the outer interface of the first protective layer to form the second protective layer.
